(19) United States
(12) Patent Application Publication
(10) Pub. No.: US 2013/0325526 A1
(43) Pub. Date: Dec. 5, 2013

(54) APPARATUS AND METHODS FOR SEATING MANAGEMENT

(71) Applicant: CHOWTIME, INC., Oakland, CA (US)

(72) Inventor: Richard T. Tyler, Oakland, CA (US)

(21) Appl. No.: 13/907,487

(22) Filed: May 31, 2013

Related U.S. Application Data
(60) Provisional application No. 61/654,505, filed on Jun. 1, 2012.

(51) Int. Cl. G06Q 10/02

(52) U.S. Cl. CPC G06Q 10/02
USPC 705/5

(57) ABSTRACT

A computerized system for seating management is described. The system can be utilized in business establishments offering general admission table service, such as a restaurant. In one embodiment, the system can be deployed as one or more portable electronic devices, such as tablet computers. Via an input/output interface, such as a touch screen display, the system can be used by one or more employees of the establishment to seat groups of customers. The system can include a simple and intuitive interface that prompts a user, such as a restaurant employee, to input information that enables the system to make intelligent seating decisions. Via output of these seating decisions, the system allows employees with minimal experience to handle the important and complex of seating management within a business establishment at a high proficiency level.

### CROSS-REFERENCE TO RELATED APPLICATIONS

This patent application claims priority under 35 U.S.C. §119(e) to U.S. Provisional Patent Application Serial No. 61/654,505, filed Jun. 1, 2012 and titled, “APPARATUS AND METHODS FOR SEATING MANAGEMENT,” which is incorporated by reference in its entirety and for all purposes.

### BACKGROUND

1. Field of the Described Embodiments

The described embodiments generally relate to restaurant management. More particularly, apparatus and method for enabling seating and reservation management using portable electronic devices are described.

2. Description of the Related Art

General admission table service is a common form of seating offered in many venues, such as restaurants, dinner theaters and comedy clubs. In general admission table service, customers arrive at the venue with reservations or without reservations and are seated at open tables as they become available. The amount of people arriving with reservations as compared to the amount of people arriving without reservations varies unpredictably over time. Further, the arriving sizes of parties without reservations that wish to be seated together vary unpredictably over time. In addition, an amount time that each party spends at a table is somewhat unpredictable. Because of these factors, seating parties to match the available table space sizes within a venue with the objectives of 1) minimizing wait times for both customers arriving with and without reservations and 2) optimizing space utilization within the venue is a difficult and complex problem. It is particularly difficult for large venues during busy periods.

It can take an individual a significant amount of time to learn how to effectively seat a particular venue. However, establishments where seating is important, such as restaurants, often have high employee turn-over rates. The employees with more experience, such as managers, who are likely to be more effective at seating management, are typically allocated to other venue management tasks. Thus, the seating management is often allocated to inexperienced employees that are likely not to be highly skilled in this area. The ability to seat effectively can be critical to the success of an establishment as poor seating choices can lead to customer dissatisfaction and inefficient use of venue resources. In view of the above, methods and apparatus that improve and simplify seating management and are applicable to a wide range of venue types are desirable.

### SUMMARY OF THE DESCRIBED EMBODIMENTS

A computerized system for seating management is described. The system can be utilized in business establishments offering general admission table service, such as a restaurant. In one embodiment, the system can be deployed on or more portable electronic devices, such as tablet computers. Using an I/O (Input/Output) interface, such as a touch screen display, the system can be used by one or more employees of the establishment to seat arriving customers. The system can be configured to manage various seating assignment functions, such as but not limited to 1) selecting a table to satisfy a seating criteria provided by an arriving party, 2) estimating wait times prior to seating, 3) pre-assigning seating to parties scheduled to arrive at the establishment or currently waiting at the establishment, 4) generating alerts and suggesting ameliorative actions when issues that affect seating management, such as a party failing to clear a table at a proscribed time or failing to arrive for a reservation, occur and 5) presenting an overall seating status information for a prescribed seating arrangement within an establishment. The system can be configured to handle parties arriving with or without reservation at an establishment.

In various embodiments, the system can utilize a statistical model to generate an estimated duration for each seating at its instantiation (the “seating duration estimate”). An individual seating may correspond to an individual table or a group of adjacent tables treated as one for the duration of a seating. As another example, the seating may also correspond to a section of a table or counter which may be shared by one or more parties concurrently. The system can maintain a list comprised of currently occupied seatings, or active seatings. A system interface allows a user to view seating related information in different formats, such as textually or graphically.

The system can maintain historical seating information in a persistent data store. The historical seating information can include information, such as but not limited to, the location of a seating, a size of the party at the seating, identity information associated with one or more members of the party, a predicted duration of the seating, how long the seating lasted, when the party was seated, when the party left, a server identifier and how much money the party spent while utilizing the seating. The system can store the historical seating information to a system database.

The historical seating information can be used to perform system functions, such as assigning seating and/or estimating wait times prior to being seated. The system can be configured to not save historical seating information in some circumstances. For example, if a party sits down and then moves or leaves within a minimum period of time, the seating effectively gets thrown out for such purposes as assigning seating and estimating seating wait times. The minimum period of time after an initial seating assignment can be configurable parameter that is input to the system. In addition, a mechanism can be provided within an interface for ‘undoing’ a seating.

The system can maintain a list of incoming reservations. The reservations can be made and viewed via a reservation interface coupled to the system. The reservations can include information, such as a time, date, party size and reservation identifier (e.g., a party name). In particular embodiments, the reservations can specify seating criteria selected by a customer, such as a request for a particular table or a seating location (e.g., indoor vs. outdoor seating, a scenic quality, such as tables adjacent to a window with a scenic view, booth or banquette seating, wheelchair accessibility, private vs. shared tables, and counters, etc.). The specified seating criteria can include one or more preferred seating parameters. The system can be configured to use the seating criteria when seating decisions are made, such as whether to assign a particular seating location to a particular party.

When a seating is not available immediately, the system can be configured to generate and maintain a waiting list. The system can be configured to generate estimated wait times. As described above, the system can be configured to generate estimates of wait times for seatings satisfying different seating criteria, such as first available versus outside only. In one embodiment, the waiting times can be generated using a statistical model that uses historical seating information stored in a seatings database. Once a party is seated, the system can be configured to display expected remaining seating durations for currently instantiated seatings. If an employee gathers information related to a seating, such as a party appearing to be leaving earlier or staying longer than an estimated seating duration, the system can be configured to accept inputs that allow the estimated seating duration to be manually adjusted.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 shows a block diagram of a seating management system including a master node and two client nodes in accordance with the described embodiments.

FIG. 2 shows a block diagram of the master and client nodes in accordance with the described embodiments.

FIGS. 3A-3C is a flow chart of a seating management workflow in accordance with the described embodiments.

FIGS. 4A-4B show screen shots of seating manager component of a graphical user interface (GUI) for a seating management system in accordance with the described embodiments.

FIGS. 5A, 5B, 5C and 5D show screen shots of using a seating manager component of the GUI to seat and unseat tables in accordance with the described embodiments.

FIGS. 6A and 6B show screen shots of the effect of an incoming reservation on the seating management component of the GUI in accordance with the described embodiments.

FIGS. 7A-7B show screen shots of a GUI of a seating manager component that allows for specifying information about new parties in a seating management system in accordance with the described embodiments.

FIG. 8 show screen shots of seating manager component of a graphical user interface (GUI) for a seating management system that allows a user to input updated seating estimate data in accordance with the described embodiments.

FIGS. 9A-9B show screen shots of seating manager component of a graphical user interface (GUI) for a seating management system in accordance with the described embodiments.

FIG. 10A shows a screen shot of a seating manager component and an alert component of a graphical user interface (GUI) for a seating management system in accordance with the described embodiments.

FIG. 10B shows a screen shot of a seating manager component and a waiting list component of a graphical user interface (GUI) for a seating management system in accordance with the described embodiments.

FIG. 11 shows a screen shot of a reservation manager component of a graphical user interface (GUI) for a seating management system in accordance with the described embodiments.

### DESCRIBED EMBODIMENTS

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

A computerized system for seating management is described. The system can be utilized in business establishments offering general admission table service, such as a restaurant, comedy club or dinner theater. In one embodiment, the system can be deployed as one or more portable electronic devices, such as tablet computers. Using an Input/Output interface, such as a touch screen display, the system can be used by one or more employees of the establishment to seat parties of arriving customers. The parties can consist of one or more persons. The system includes a simple and intuitive interface that prompts a user, such as a restaurant employee, to input information that enables the system to make intelligent seating decisions. Via output of these seating decisions, the system allows employees with minimal experience to handle the important and complex task of seating management within a business establishment at a high proficiency level.

A business establishment offering general admission table service is one where groups of customers, possibly holding the equivalent of general admission tickets or advance reservations without pre-assigned seating, are assigned seating from one or more categories within the establishment prior to consuming services and/or products offered by that establishment. Examples of such establishments would include but are not be limited to restaurants, dinner theaters, and comedy clubs. Different categories of seating would include private tables, shared tables, counter seating, as well as groups of adjacent private tables which are seated together, known as combined tables. The services and/or products delivered to groups of customers may be fully or partially paid for, on a discounted basis or at face value, at any time prior to or subsequent to the acquisition of tickets or reservations when applicable.

The system can be configured to maintain a continuously updated virtual representation of one or more seating configurations for the establishment in a persistent data store. The persistent data store can be located on devices on which the system is deployed and/or in the cloud. In particular embodiments, within a configurable period of time prior to the arrival of a reserved party, the system makes seating decisions, such as pre-assigning seating to the arriving party. The seating is selected to accommodate the party at the scheduled time of arrival or near as possible to the scheduled time of arrival.

If seating is immediately available to accommodate a reserved or walk-in party upon arrival, the system can be configured to assign seating to the party if not pre-assigned, as in the case of a reserved party. In addition, the system can be configured to determine whether alternative seating is available. If alternative seating is available, the system can be configured to output the alternative via the system interface. User can use the system interface to select and assign different seating. When seating is not immediately available to accommodate the party, the system can generate an estimated wait time based on such factors including but not limited to one or more of the size of the party, current seatings (e.g., occupied tables), the identity of one or more members of the party, historical seating data, scheduled event information, optional seating criteria which may have been specified by the party and combinations thereof.

In some embodiments, the system can be configured to give preferred seating to an identified individual. The preferred seating can include a preferred seating location, moving the individual and their party ahead of one or more other parties in a waiting list and even giving the individual a seating object previously reserved for another party. Thus, as described above, the estimated wait time may depend on the identity of one or more members of the party.

If a party is required to wait, the system can attempt to pre-assign currently occupied seating to the party which satisfies its requirements and which is anticipated to become available in a timely manner. When seating which has been pre-assigned to a waiting party becomes available, the system can be configured to issue a notification of that fact to one or more employees. In one embodiment, the system can also optionally send a notification message to a customer controlled device, such as a smart phone.

When seating which has been pre-assigned to a reserved party not yet arrived becomes available, the system can be configured to prevent employees from selecting and seating other parties at that location for a preconfigured period of time after the party's scheduled arrival time. This feature can be referred to as a “hold.” The system can be configured to detect whenever a seating pre-assigned to a waiting party is running over time and this fact is brought to the attention of one or more employees to facilitate ameliorative action if possible. Ameliorative actions in this circumstance might include asking the table's server to expedite the conclusion of the seating and/or offering a complementary appetizer to the waiting party. In some instances, the system can be configured to suggest ameliorative actions to the user.

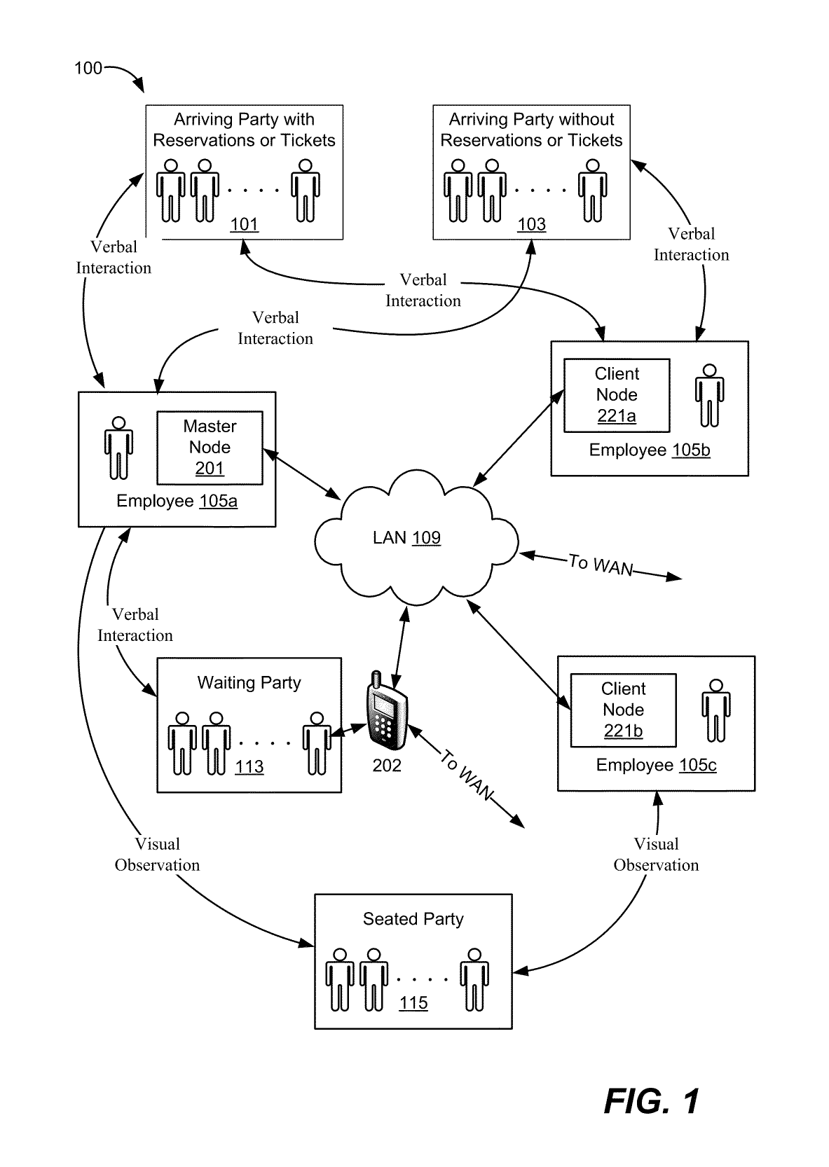

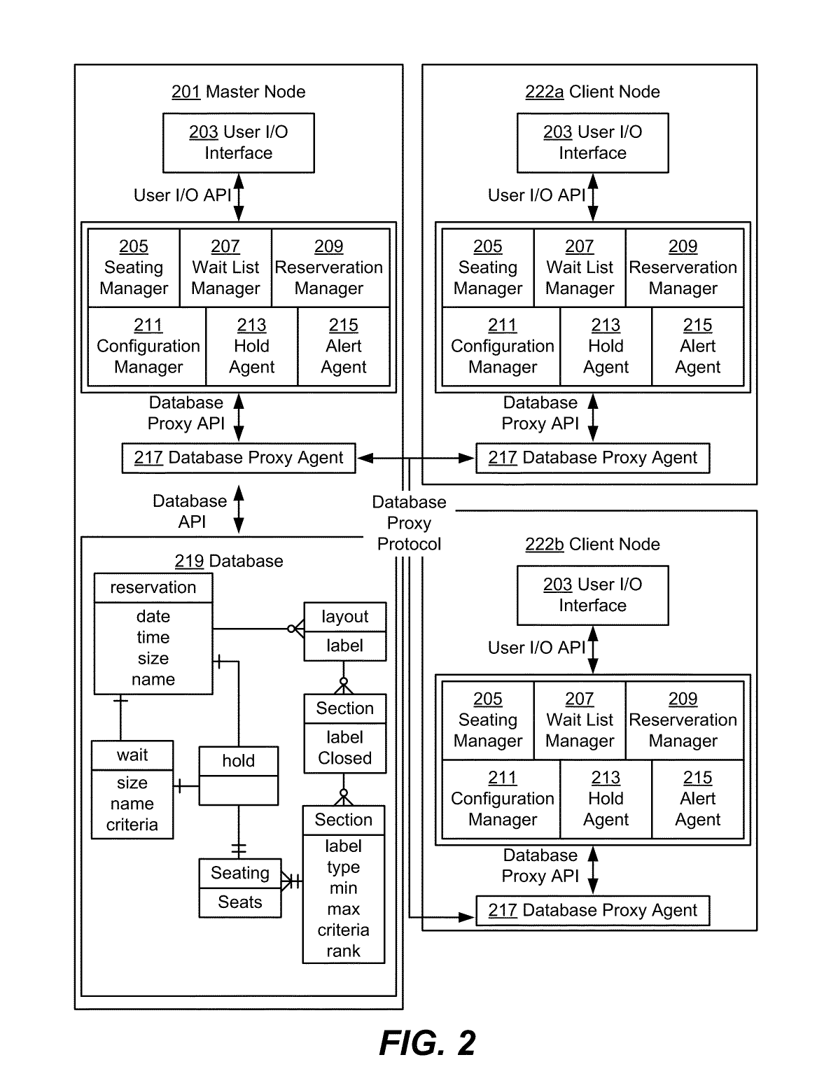

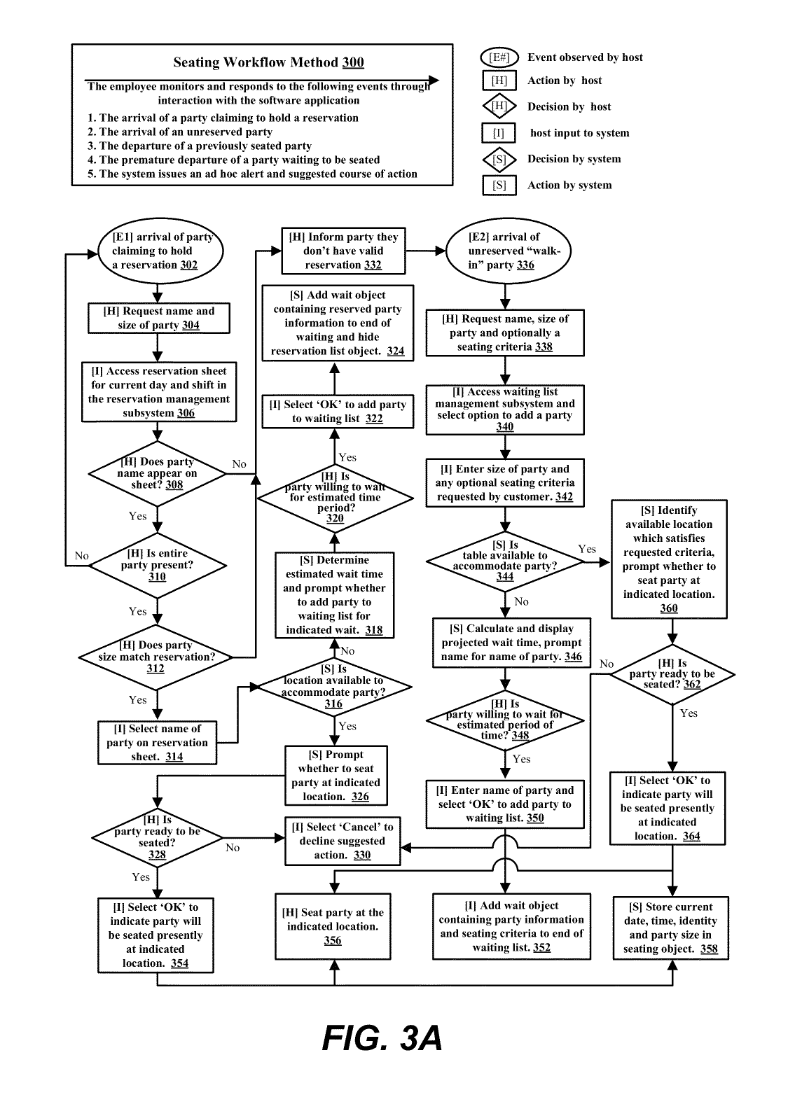

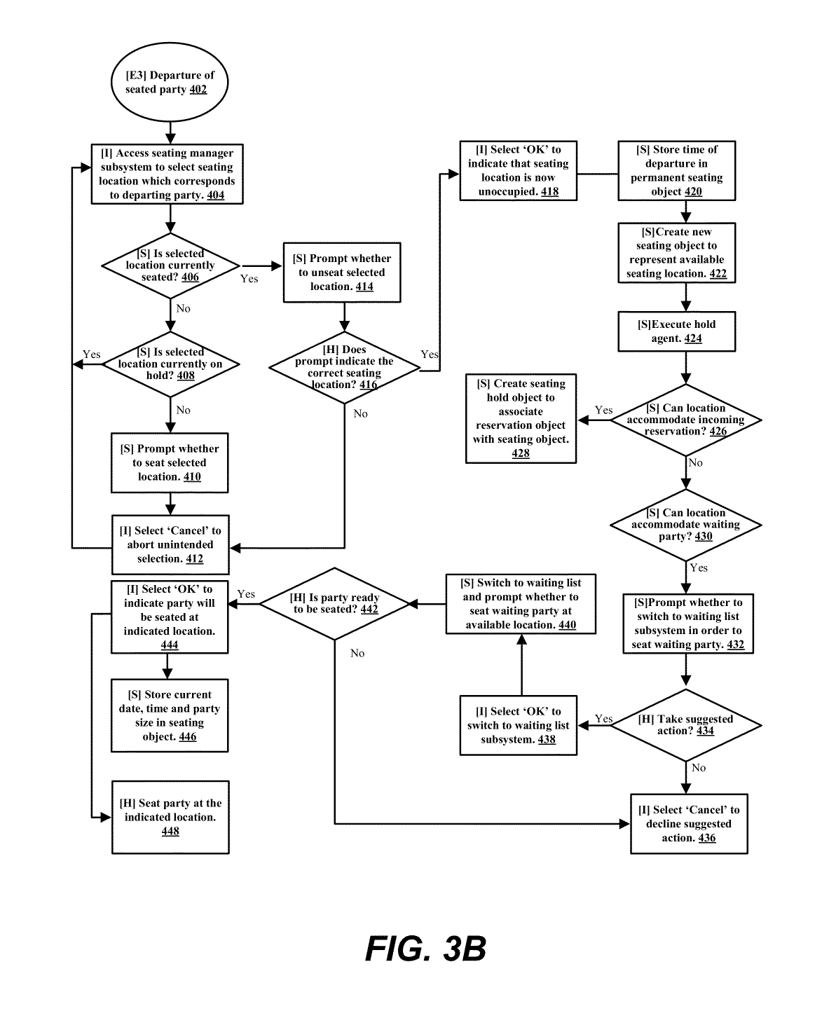

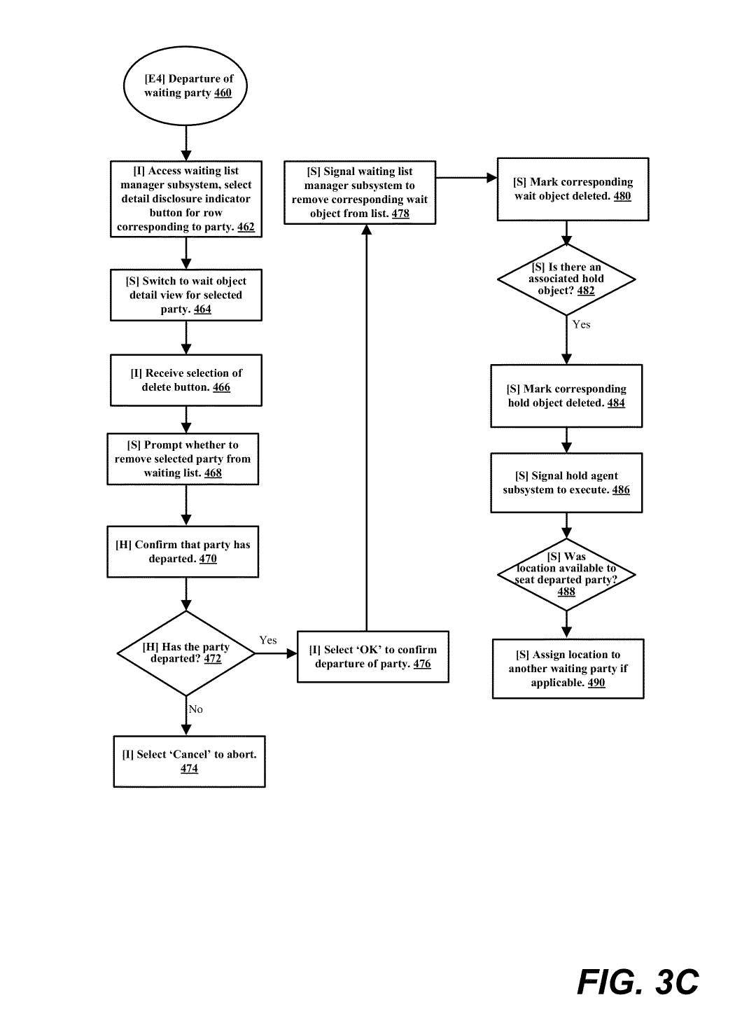

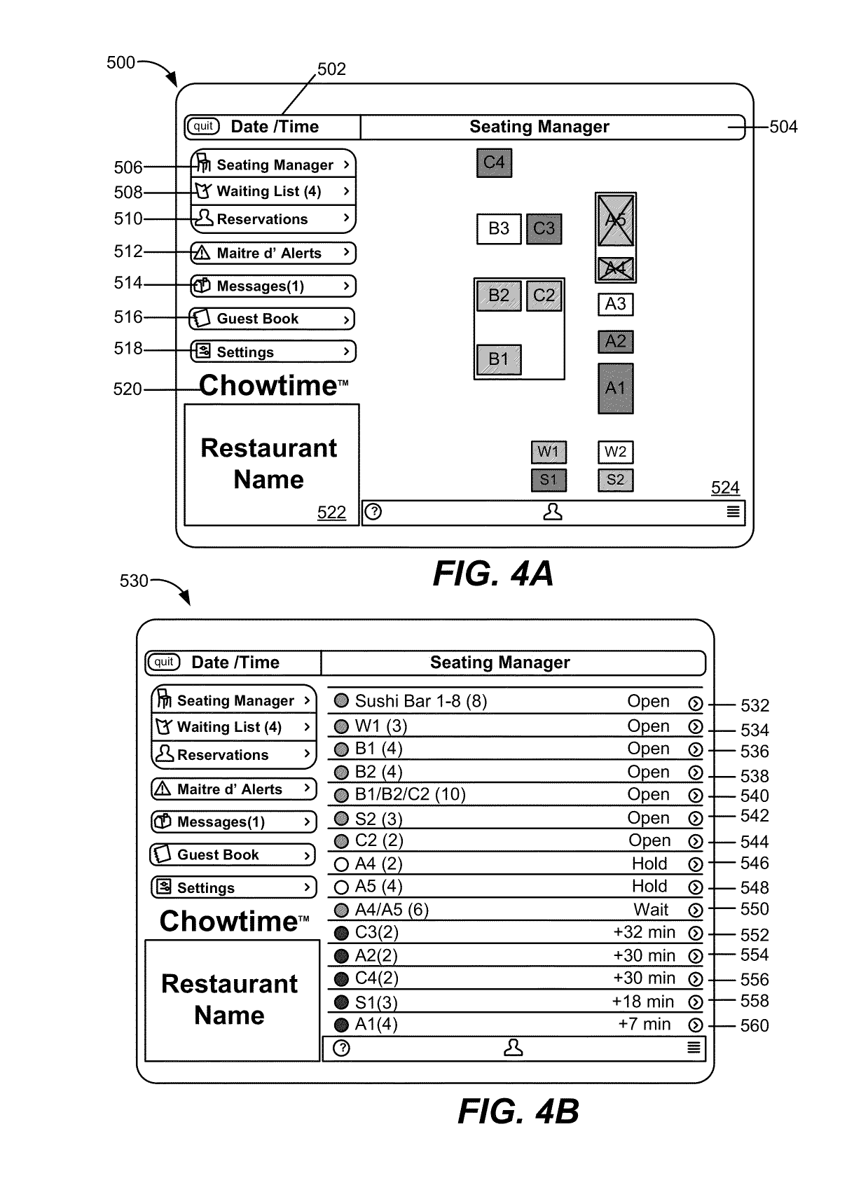

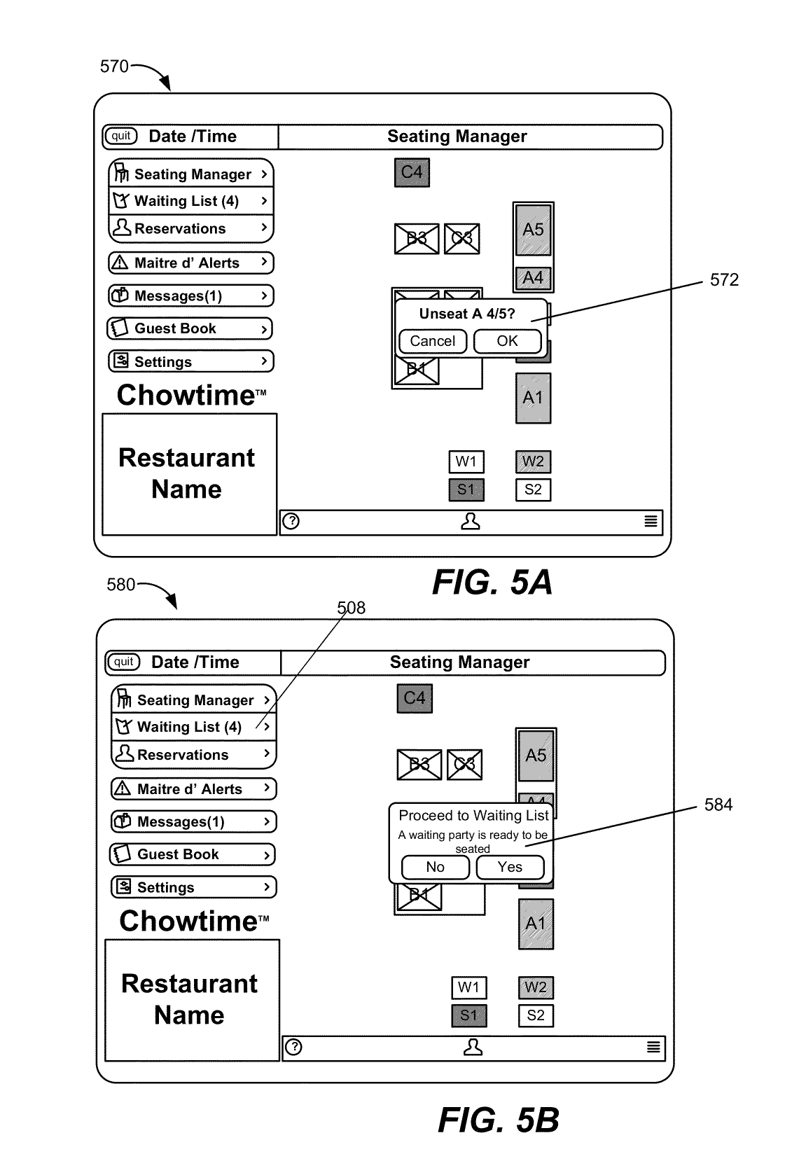

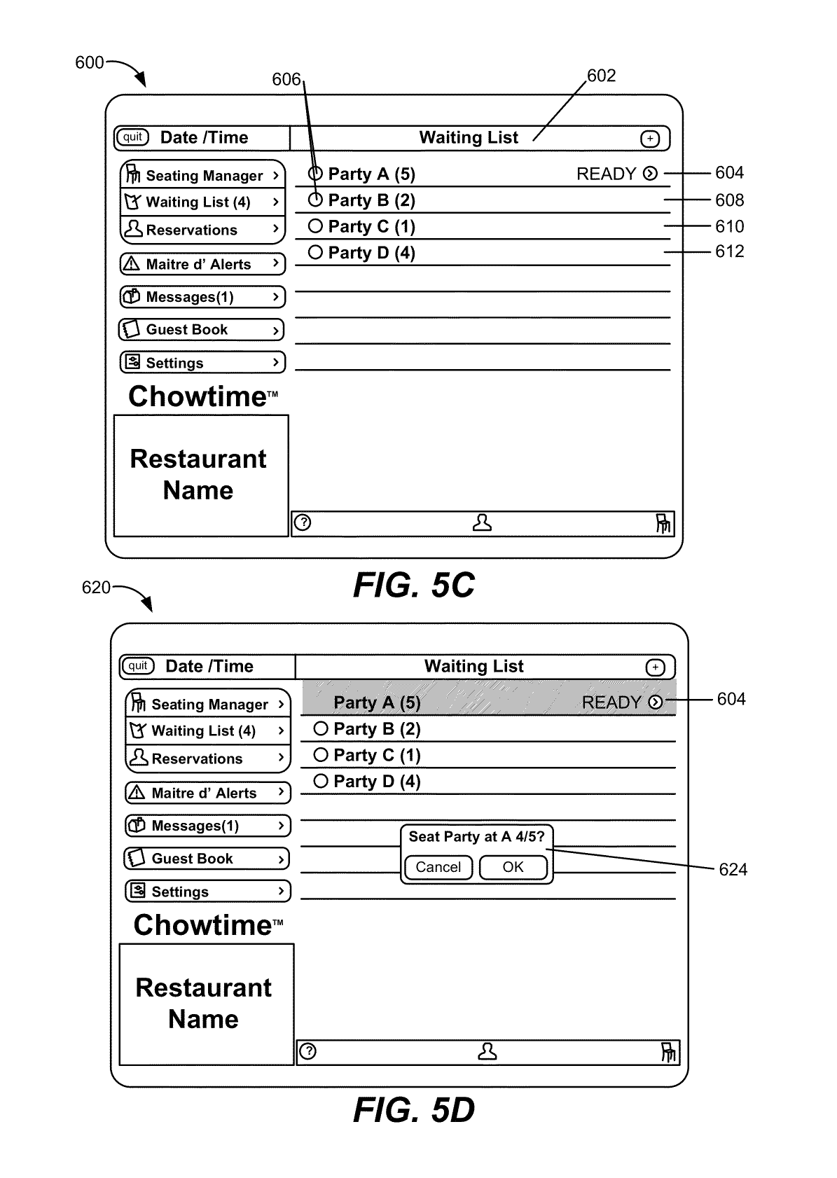

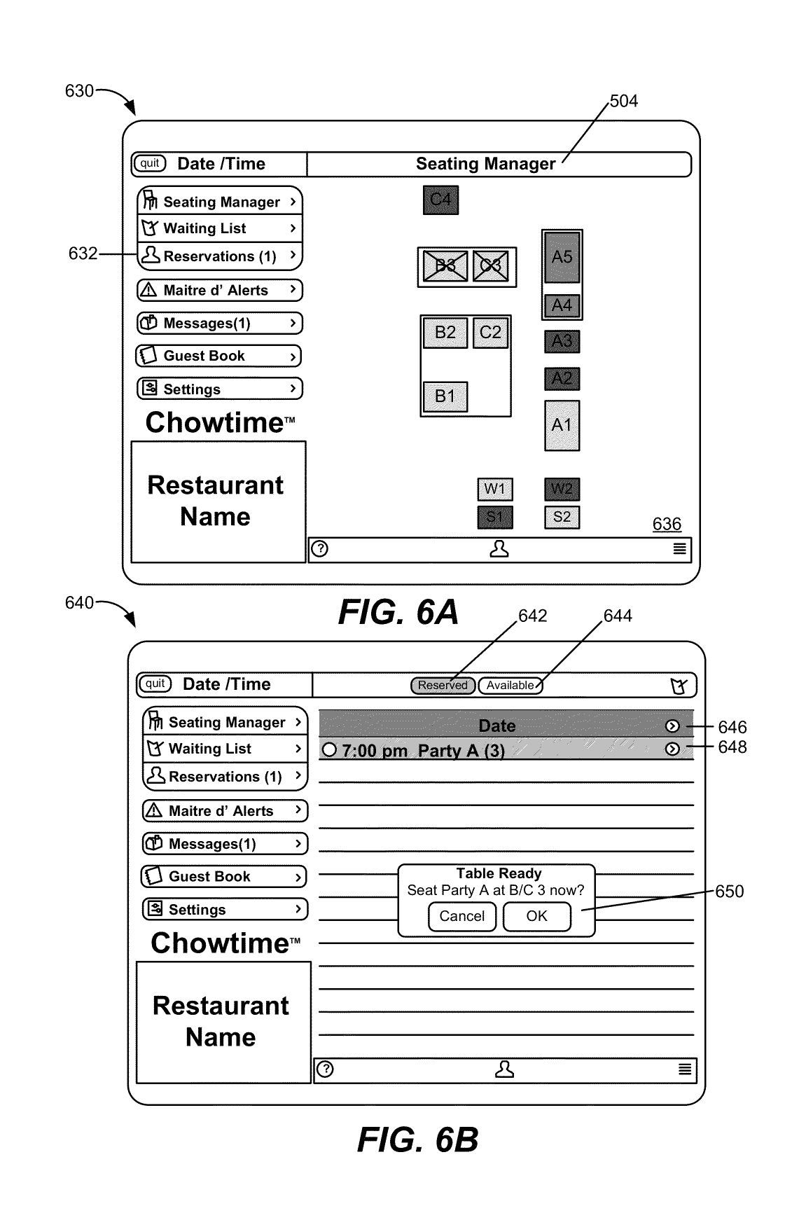

Details of embodiments involving seating management are described in more details with respect to the following figures. In particular, with respect to FIG. 1, a block diagram of a seating management system including a master node and two client nodes are described. Components of master and client nodes that can be utilized in the system are discussed with respect to FIG. 2. A workflow for a seating method is described with respect to FIGS. 3A-3C. With respect to FIGS. 4A and 4B, screen shots of a GUI including a seating manager component are described. With respect to FIGS. 5A, 5B screen shots involving examples of using the seating manager component of the GUI to seat and unseat tables are discussed. A system component for managing a waitlist is described with respect to FIGS. 5C and 5D. Finally, with respect to FIGS. 6A and 6B, screen shots showing the effect of an incoming reservation on the seating management component of the GUI are described.

### Seating Management System

In this section, a seating management system that can be utilized in business establishments, such as restaurants, to provide general admission seating is described with respect to FIGS. 1 and 2. FIG. 1 shows a block diagram of a seating management system 100 including a master node 200, two client nodes, 221a and 221b and a user controlled device 202. First, components of the system 100 are described, such as the master node and client nodes. Then, the utilization of the components in the context of system is described. In one embodiment, the system can be applied to seating management in a venue, such as a restaurant, dinner theater or comedy club.

The master node 201 and additional client nodes, such as 221a and 221b can be utilized and possibly carried by employees of an establishment to provide seating services for visiting parties, such as parties arriving with or without reservations. For example, employees 105a, 105b and 105c can use the master and client nodes to seat visiting parties 101 and 103. In the example of FIG. 1, employee 105a controls the master node 201 and employees 105b and 105c control client nodes 221a and 221b, respectively. In one embodiment, the system requires at least one master node, such as 201, that includes a system database. If needed, one or more additional client nodes, such as 221a and 221b, can be provided. The number of nodes that are utilized in the system can depend on the size of the establishment and the number of employees performing seating services. Thus, the components, such as the master node and client nodes, and their utilization are described for the purposes of illustration only and are not meant to be limiting. For example, system configurations are possible where there is only a master node and no client nodes, where the there is a master node and a single client node or where there is a master node and more than two client nodes.

In particular embodiments, the master node and two client nodes can be portable computing devices, such as tablet computers, laptop computers, netbook computers or smart phones. For example, the master node and two client nodes can be tablet computers, such as an iPad™ by Apple™ (Cupertino, Calif.). One of the nodes can also be a less portable device, such as a desktop computer, if desired. The master and client nodes can include at least one processor, temporary memory and persistent memory. The persistent memory can be used to store system data, such as historical seating information or current reservations. Block diagrams of the master node 201 and client nodes, 221a and 221b, are described in more detail with respect to FIG. 2.

In one embodiment, the master node and client nodes can be configured to communicate with one another via a local area network (LAN) within the establishment, such as a LAN 109. The LAN 109 can be coupled to a wide area network, such as the Internet. Via the WAN connection, the system 100 can receive communications from remote devices. For example, via the WAN, the master node 201 can receive requests for seating reservations from a remote device, such as a remote server configured to provide reservation services for one or more establishments. Opentable™ Inc (San Francisco, Calif.) is one example of a company that provides reservation services for restaurants.

In a particular embodiment, the seating management system 100 can be configured to communicate with customer controlled devices. For example, a member of party 113 is shown using device 202 to communicate with system 100 via a direct connection to LAN 109. Device 202 can include wide area network capabilities, such as access to a cellular data network. The wide area network capabilities may allow customer controlled devices, such as 202, to access the LAN 109 via a wide area network. Like the client and master nodes, device 202 can be portable computing device, such as a smart phone or a tablet computer.

In one embodiment, via a customer controlled device, such as 202, a customer can receive an electronic communication from the system 100. For example, the system 100 can send a text message to device 202 to indicate a table is now available or to send an update regarding an expected wait time. In another embodiment, the system 100 can be configured to receive an update of a seating preference from a customer via a customer controlled device. For example, when a customer arrives at the establishment, they can specify seating criteria, such as a desire for an outdoor table. While waiting, the customer may change their mind regarding their selected seating criteria and via their device 202 indicate a different seating criteria. For example, the system 100 can be configured to allow the customer to change their criteria from an outside seating to a first available seating.

To provide services, such as seating services, the restaurant management system 100 can rely on information gathered from employees through verbal interactions or visual observations. Portions of the gathered information can be subsequently entered into the system 100 via interfaces associated with the master node and client nodes. For example, employee 105a or 105b can communicate verbally with arriving parties, such as 101 and 103. Via their verbal communications, the employees can gathered information such as but not limited to 1) whether the party has a reservation or a ticket, 2) how many members are in their party, 3) whether all the members have arrived, 4) information used to locate a reservation, such as a first and/or last name and a reservation time, and 5) desired seating criteria, such as indoor/outdoor, etc. Portions of the gathered information, such as the number of members in a party or a desired seating criterion, can be entered into the system. The system can use this information to make intelligent seating decisions.

As an example of visual observation, employees can observe when a party is seated and then observe when a seating is vacated. For instance, employee 105a using master node 201 or employee 105c using client node 115 can observe when seated party 115 vacates their seating. Using their node, employee 105a or 105c can input into the system that the party 115 has left. The system 100 can store the received information to provide a historical record of how the long the seating was occupied. The system 100 can later use the historical record to estimate future wait times. In addition, the input indicating the seating has vacated can be used to update reservation and waiting lists currently maintained by the system.

Besides receiving information from employees, the system 100 can be configured to output information to employees where some of the information can be then transmitted from the employees to the customers. For example, the system 100 can output a seating recommendation that satisfies the input of seating criteria. Based upon the seating recommendation, the employee can lead a party to the recommended seating. As another example, the system 100 can output an estimated waiting time for a party. An employee, such as 105a using master node 201, can receive this information from the system and then verbally communicate it to the waiting party.

Other communication methods, besides verbal communication, can be used to transfer information from employees to customers. For example, in one embodiment, a ticket can be generated with the estimated wait time and the requested seating criteria and the ticket can be handed to a member of the waiting party. The ticket may include a record identifier that uniquely identifies a record in the system associated with the waiting party and an estimated wait time. As another example, this information can be transmitted electronically from the system to a user controlled device, such as a smart phone. As yet another example, this information can be posted to an Internet location and periodically updated as conditions change such that it can be made available to the user from a user controlled device like a smart phone. In one embodiment, the user can be provided a link, such as in a text format or in a QR code format (or other optically data image format), to the Internet location.

Next, additional details of the master and client nodes are described with respect to FIG. 2. Further details of a work flow involving interactions between an employee, customers and the system 100 are described in more detail in the next section with respect to FIGS. 3A, 3B and 3C. FIG. 2 shows a block diagram of the master 201 and client nodes, 222a and 222b. As described above, different combinations of master and client nodes are possible and this example is provided for the purposes of illustration only and is not meant to be limiting. In one embodiment, the restaurant management system can be configured to allow a user to specify whether a node is to be a master node or a client node. Thus, via inputs to the system, client node 222a can be reconfigured as a master node and master node 201 can be reconfigured as a client node. An advantage of this approach is that if a designated master node becomes inoperable for some reason a client node can be reconfigured as the master node and the system can continue operating.

As will be described in more detail below, the master node, such as 201, can include database functions that are not provided by the client nodes, such as 222a and 222b. However, a copy of the database can be stored on the cloud. Thus, in one embodiment, a client node can be configured as a master node by downloading a copy of the database for local storage on the master node.

Each node, such as 201, 222a and 222b can include a processor, a memory and one or more communication interfaces that allow the nodes to communicate directly with one another directly (peer-to-peer communications) or via a LAN. In addition, the nodes can be configured to communicate with other devices, such as customer controlled devices or remote servers (e.g., a server providing reservation services). In addition, the nodes can include output interface devices and input interface devices which are used to provide a user I/O interface 203. Examples of output interface devices include video displays, audio devices (e.g., speaker or headphone jack) and haptic devices (e.g., buzzers that generate vibrations). Examples of input devices include a touch sensor, tilt or movement sensors, a keyboard, a mouse, an image capture device (e.g., for gesture recognition) and a sound capture device, such as a microphone (e.g., for voice recognition).

Nodes can be configured on devices with different input and output capabilities. For example, a node can be configured on a tablet computer with a touch screen display and voice input capabilities. As another example, a node can be configured on a laptop computer where a display is used to output information and a keyboard and a mouse is used to input information and make selections using a system interface.

The user I/O interface 203 on each node can be used to access various functions of the system. The inputs and outputs that the system is configured to accept and output can be described by a user I/O application program interface (API). A few examples of functions that can be accessed via the user I/O API include but are not limited to a seating manager 205, a wait list manager 207, a reservation manager 209, a configuration manager 211, a hold agent 213 and an alert agent 215.

As is described in more detail below with respect to FIGS. 4A, 4B, 5A, 5B and 6A, the seating manager 205 can be used to make intelligent seating decisions that allow employees to seat parties within an establishment according to a particular seating layout. The intelligent seating decisions can be based upon historical seating data and current seating data, such as a party size, input by an employee. The seating manager component 205 can be configured to output seating status information, such as whether seats are occupied, reserved or on hold. In addition, the seating manager component 205 can be configured to determine estimates of wait times and seating durations. In one embodiment, the estimated wait times and seating durations can be determined using statistical models that utilize the historical seating data.

The wait list manager 207 can be used to create and maintain a list of parties waiting for seating. As seatings becomes available, the wait list can be checked and parties can be removed from the wait list when the available seatings meets the requirements of the party on the waitlist. The reservation manager 209 can be used to maintain a list of parties that have requested reservations and information about the reservation, such as a party size and an arrival time. Near the time of arrival as indicated in a reservation, the system can be configured to pre-assign seating to the arriving party.

The configuration manager 211 can be used to input system configuration information, such as a selection of a seating configuration to utilize and other system parameters, such as a minimum seating time that is to be exceeded before seating data associated with a particular seating is saved as historical seating data. The hold agent 213 can be used to hold a seating selected for a party. For example, at about the schedule time of arrival with a reservation, the system can be configured to select available seating that is compatible with the reservation and then place the selected seating on hold. The selected seating can remain on hold until it is released by the hold agent 213. While the seating is on hold, the system won't attempt to select the seating for other parties.

The alert agent 215 can be configured to alert employees to potential issues related to the system. In one embodiment, if a seating is lasting beyond an estimated duration by some amount, the system can generate alert and optionally suggest an ameliorative action that can remedy the situation. For example, the system can notify an employee to contact a waiting party and offer them a free appetizer when it is determined that the party's wait has exceeded some threshold amount. In addition, the system can suggest that an employee attempt to clear a needed seating. In response, the employee can carry out the ameliorative action such as asking party to clear the needed seating.

A database proxy API can be defined that allows the system components to retrieve needed information from a database 219, such as historical seating, using a database proxy agent 217. Each node, such as 201, 222a and 222b can include a database proxy agent. However, in one embodiment, the database itself may be stored on only one of the nodes. In the example of FIG. 2, the master node 201 includes the database 219. Alternatively, a copy of the database 219 or the database itself can reside in the cloud.

The database proxy agent 217 on each node can communicate with the database 219 according to rules specified in a database API using a database proxy protocol. The database 219 can store active reservation objects that define parties with reservations. The reservation object can include information, such as but not limited to, a date, time, size, name and seating criteria (not shown). A wait object can be stored in the database 219 that includes information about one or more parties currently residing on a waiting list. The wait object can include information, such as a size, name and seating criteria associated with the waiting party.

The hold object in database can store information regarding seating objects that are currently on hold. In FIG. 2, no seating objects are shown as being on hold. The seating objects can include one or more seating locations. Thus, seating objects can have overlapping seats. For example, a first seating object can be generated that includes a first seating location and a second seating location that can be seated together. Whereas a second and third seating objects can each include one of the first seating location or the second seating location in the first seating object. All three seating objects can be instantiated simultaneously, as the system can be configured to decide between 1) seating a larger party using the first seating object including two seating locations or 2) seating two smaller parties at each of the second and third seating objects. Further details of seating locations that can be combined to create a seating object with a larger capacity or separated into seating objects with a smaller capacity are described with respect to FIGS. 4A and 4B.

The database 219 can be configured to store one or more different seating layouts. Each of the seating layouts can be given a label. In one embodiment, different seating layouts can be created by closing available seating without changing the locations of various seating locations in the seating layout. In other embodiments, the number of seat locations and their respective locations relative to one another can vary from layout to layout. A seating layout can be broken out into different sections. Information can be stored about each section in the database 219. Information about each section can include but is not limited to a type (e.g., bar seating or separate tables), minimum number of people that are allowed to be seated, a maximum number of people that can be seated, seating criteria (e.g., indoor, outdoor, booths, tables, window, interior, etc) and a rank.

The rank can be an indicator of a relative value placed on the section. For example, certain sections at different locations within an establishment can receive a higher rank than other sections. For example, in a dinner theater, a section closer to the stage can receive a higher rank than a section away from the stage. As another example, in a restaurant, a section with seats next to a window with a scenic view can be given a higher rank than a section in the interior of the restaurant. If desired individual seats in a section can be given separate ranks that vary from seat to seat.

Using the rank, the system can determine that highest ranked seating that is available. If multiple seating options are available, then the system can be configured to select the seating option with the highest rank (i.e., best available). In some instances, parties can be given preferential access to sections or seats with a higher rank. For example, a party with reservations can be given preferential access to sections with a higher rank over walk-in parties without reservations. As another example, a preferred customer (e.g., a frequent customer) can be given preferential access to sections or seats with a higher rank as compared to customers without a known visitation history at the establishment.

In yet another embodiment, a server can affect a rank. The system can be configured to track which servers are assigned to certain seating sections or groups of seats. The system can keep track of how many patrons each server is serving at a particular time. For example, a server can be assigned a section which seats a certain number of patrons and the system can keep track of a fraction of the total patrons which the server is currently serving. Further, the state of the service for each party (e.g., just seated, orders taken, appetizers delivered, main meals delivered, dessert delivered, check delivered, etc.) can be tracked.

Based upon the number of patrons a server is serving and/or the status of service for each party, the system can adjust the ranking of seating objects associated with each server. The rankings can help evenly distribute work among the servers. For example, a first seating object associated with a first server can be ranked higher than a second seating object associated with a second server because the second server is determined to be busier than the first server. In this example, other factors which affect ranking, such as the seating object size and the location ranking of the first seating object and the second seating object, can be the same.

When other factors are considered, certain ranking parameters may outweigh one another. For instance, in the example above, the first server is less busy than the second server. However, if the seating object associated with the second server is in a location which is considered more desirable than the location associated with the first server, then the second seating object may still be ranked higher than the first seating object which may lead to the second seating object being assigned first even though the second server is determined to be more busy than the first server.

In another embodiment, the system may allow an input which enables a request for a particular server. With a reservation, the system can attempt to find a seating object associated with a particular server based upon a work schedule provided to the system. If a work schedule is not available or the person is not working on the day on which the reservation is requested, then the system can suggest another seating object which meets the seating parameters associated with the reservation, such as the party size. In the example, where a work schedule is not available, the system can be configured to check in the future when a work schedule is provided and then attempt to assign a seating object associated with the requested server to the reservation.

In the case of a party showing up without a reservation and requesting a particular server, the system can be configured to check if the server is working and has at least one associated seating object which meets at least a portion of the party's seating parameters, such as a party size. If so, then the system can be configured to determine a wait time associated with the first seating object which will likely become available which is also associated with the requested server. Then, the party can be placed in a queue for this seating object. If the server is not working, the system can be configured to display a message indicating this circumstance so that the requesting party can be notified.

In yet another embodiment, the system can be configured to accept an input which reflects a skill level associated with a server. This input can affect the rankings of seating objects associated with the server. Thus, all other factors being the same, a server with a higher skill ranking can have seating objects which are ranked higher than a server with a lower skill ranking. In one instance, when a status of a patron in a party is available, a patron with a higher status, such as a VIP, can be automatically be assigned a seating object associated with a server having the highest skill level or being at least known as an acceptable server to the VIP.

### Seating System Workflow

In this section, an example of a workflow 300 that shows employee interactions with the seating management system in the context of various events is described with respect to FIGS. 3A, 3B and 3C. As shown in FIG. 3A, the example events that are discussed include but are not limited to 1) the arrival of a party claiming to hold a reservation, 2) the arrival of a party without a reservation, 3) the departure of a previously seated party, 4) the premature departure of a party waiting to be seated and 5) an ad hoc alert and suggested course of action by the system. An alert to offer waiting party a free appetizer when their waiting time has exceeded a threshold amount is one example of an ad hoc alert and suggested course of action that can be generated by the system.

As shown in the FIG. 3A, within the workflow 300, events observed by a host, actions taken by a host, decision made by a host, host inputs into the system, decisions by the system and actions performed by the system are defined. The division of work between the restaurant host and the system is provided for the purposes of illustration and is not meant to limiting. In alternate embodiments, decisions or actions performed by the host can be performed by the system or decisions or actions performed by the system can be performed by the host.

In 302, a party arrives claiming to hold a reservation. The party can be recognized by an establishment employee. In response, in 304, the host can request an identifier from a member of the party, such as a name, which allows the reservation to be located within the seating system. In 306, the employee can use the system interface to access a reservation sheet for the current day and shift. An example of a reservation accessed via the interface is described with respect to FIG. 6B.

In 308, the user can determine whether the party name appears on the reservation sheet. In one embodiment, the system interface can be configured to accept an input of the party name and search the reservation list based upon the party name. When the party is not located on the reservation list, then the employee can inform the party that the system doesn't include a valid record of their reservation. At this point, the party can be processed as a “walk-in” party without a reservation.

In 310, when a valid reservation is identified for the party, the host can determine whether the entire party has arrived via observation or via verbal communications with a party member. In one embodiment, if the party has not arrived, the seating of the party can be delayed until the host is informed that the entire party has arrived. In 312, if the entire party is present, the host can see if the party size matches the reservation. In one embodiment, if the party size doesn't match the reservation, the method can progress to 336 where the party is treated as a walk-in without a reservation.

In another embodiment, if the party size doesn't match the size on the reservation, the system can be configured to select and assign seating for the party as if the party size did match. For example, if a reservation was for three people and four people show up or the reservation was for five people and only four arrive, the system can be configured to allow a user to change the party size from three to four or five to four on the reservation and then proceed with processing the reservation. In 314, when it is determined the party size does match the reservation, the system can be configured to receive a selection of one of the reservations on the reservation list.

In 316, the system can determine whether a seating is available to accommodate the party. As described above, the determination can be based upon a seating criteria previously specified in the reservation. In one embodiment, the determination of whether seating is available to accommodate the party can be made when the host indicates to the system that all of the party is present.

In another embodiment, at some time near the arrival time specified in the reservation, such as 5 or 10 minutes before the arrival time, the system can be configured to determine whether a seating is available to accommodate the party expected to arrive according to the reservation. If a seating is available, the system can hold the seating for some time period, such as up to fifteen minutes after the expected arrival time. If the system doesn't receive an indication that the expected party has arrived within some time period, such as within 15 minutes of the expected arrival time, then the system can release the held seats.

In 326, the system can determine a seating is available that satisfies the party size requirements as well as additional seating criteria specified in the reservation. In response, the system can be configured to output details about the seating such as its location. In one embodiment, the system can determine that multiple seatings are available and notify the user of the locations of the multiple seatings that can be utilized. Based upon a preference specified by the customer, the user can select one the seatings. In an additional embodiment (not shown), the system can be configured to allow the user to proceed to the seating manager and manually select the desired seating. The selection can made from any available seating in addition to that being held by the system.

The location of the seating or seatings that are available can be conveyed in a graphical manner. For example, the interface can output a graphical layout of an establishment including a seating configuration with a location of each seating where the seating or seatings that are available to accommodate the reservation are indicated in some manner. For example, the available seatings can be color-coded to indicate their availability. As another example, the available seatings can flash to indicate their availability. Examples of conveying information related to available seating is described in more detail with respect to FIGS. 4A and 4B.

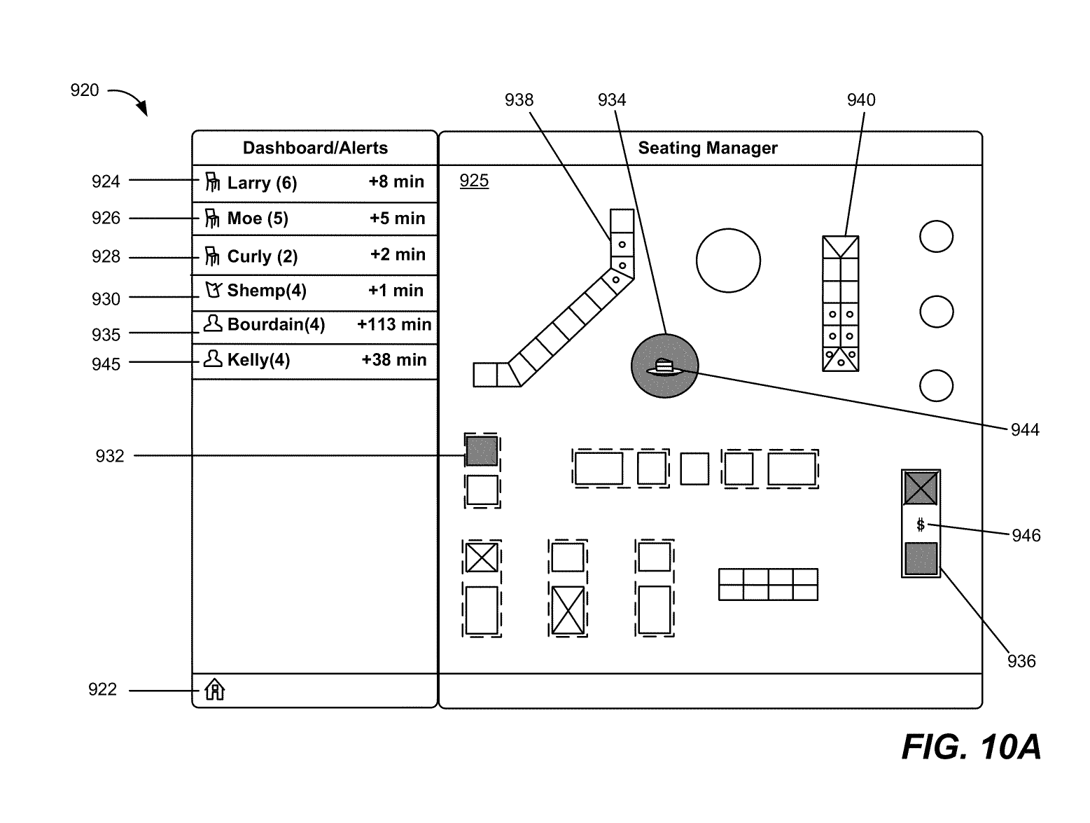

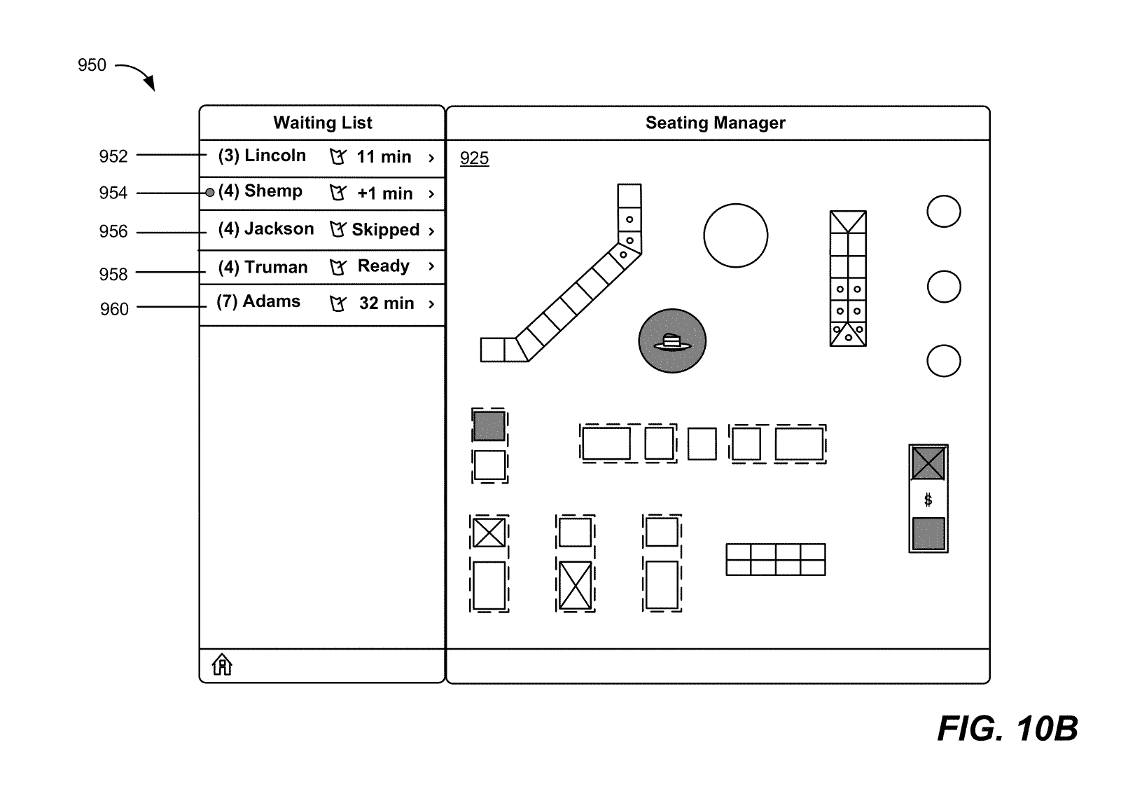

In 326, the system can prompt the user whether to seat party at a single indicated location or at one of multiple indicated locations. In one embodiment, the user can either accept one of the suggested seating locations or choose another. For example, by dragging an entry from a reservation list to an available table in the seating manager graphical representation and ‘dropping’ the entry on the chosen table, the user may be able select within the interface an open table. An example is described in more detail with respect to FIG. 10B. In 328, the host can determine whether the party is ready to be seated. If the party is not ready to be seated, in 330, the user can provide an input via the interface that cancels the suggested action. In one embodiment, response to the cancellation, the interface can return to a default or home state, such as a state from which a seating can be initiated.

In 354, when the party is ready to be seated the user can indicate via the interface that the party is to be seated in the indicated location and in 356, the user can seat the party at the indicated location. In 358, a seating object can be instantiated in the database (see FIG. 2) and information such as but not limited to the current date, time, seating location, seating layout, identity of one or more members of a party and party size can be stored with seating object. In one embodiment, if the seating lasts over a prescribed amount of time then information associated with the seating object can be saved as historical seating data. As described above, the historical seating data can be used in a statistical model to estimate wait times and expected seating durations that are utilized by the system.

In 318, when a seating location is not available to accommodate the party, the system can determine an estimated wait time for a seating to become available. Then, the system can prompt the user whether to add the party to a waiting list. In one embodiment, the system can determine estimated wait times for seatings meeting different criteria, such as indoor versus outdoor or counter seating versus table seating. The estimated wait times each of the seatings including the seating criteria can be output by the system. The system can prompt the user to describe the different seatings and their associated wait times to the customer and then prompt the user to select one of the seatings if the customer indicates their desire to wait for one of the indicated seating options.

In 320, the host can determine if the party is willing to wait for the estimated time period. The determination can based upon verbal communications between the system user and a party member. If the party agrees to wait, the user can interact with the system to add the party to a waiting list. For example, in 322, the user can select a graphical input button, such as a button labeled “OK” to indicate that the party is to be added to the waiting list. In response, in 324, a wait object including party information, such as a size and seating criteria can be instantiated and added to the end of the wait list. In one embodiment, the system can return to a default state or home state and the reservation related data can be hidden. In 320, if the party is not willing to wait, then the system can be returned to a default or home state that allows the user to respond to the next event, such as an arrival of a new party.

Besides the arrival of a party with reservations, another event to which the system can be configured to respond is an arrival of a party without reservations (i.e., a “walk-in” party). An occurrence of a “walk-in” event is shown in 336. In response to determining a “walk-in” event has occurred, in 338, the user can seating related information from the party. In one embodiment, the interface can be configured to allow a user to indicate a “walk-in” event has occurred. For example, a selectable button can be provided in a GUI for a “walk-in” event. In response to a selection of the button, the interface can enter into a state where it is ready to process a “walk-in” event and then prompt the user for information to obtain, such as the seating related information, obtained in 338.

In 340, via the interface, a user can access the waiting list management subsystem and select an option that allows them to add a party to the waiting list. In 342, the user can input information that allows a waiting list object to be created, such as a size of the party and optionally seating criteria, such as indoor, outdoor, counter or table, etc. In 344, the system can determine whether a seating is immediately available to accommodate the party.

In 346, when a seating is not immediately available, the system can determine and output to the interface a projected wait time and prompt the user to enter an identifier, such as a name, which can be associated with the wait list object. As described above, in a particular embodiment, the system can be configured to estimate multiple wait times that satisfy different seating criteria. The different wait times can be output via the interface and then the user can communicate this information to a member of the walk-in party.

In 348, the user can determine whether the party is willing to accept the estimated wait time. When the party is not willing to wait, the user can select an option in the interface indicative of the party's decision and the interface can be returned to a home or default state where it is ready to respond to the next event, such as the arrival of a new party. In 350, when the user determines the party is willing to wait, the user can input party identification information, such as a name. In response, the system can create a new wait list object and add it to the end of the waiting list.

In 360, when the system determines a seating is available which satisfies the requested criteria, such as the party size, the system can prompt the user in regards to whether to seat the party at the determined location. A temporary hold can be placed on the seating so that another user doesn't attempt to seat someone at the location. In one embodiment, the location can be indicated graphically on the interface. For example, the available location can be colored coded and/or additional graphical effects can be used to indicate the location, such as flashing. In an additional embodiment (not shown), the system can be configured to allow the user to proceed to the seating manager and manually select the desired seating. The selection can made from any available seating in addition to that being held by the system.

In 362, the user can determine whether the party is ready to be seated. The user can make the determination via a verbal communication with the party. The interface, however, may prompt the user to make this determination, such as by outputting the message-“Is the party ready to be seated.” In one embodiment, selectable input buttons, such as input buttons labeled, “yes” or “no” can be displayed along with the message.

In 330, when the party is not ready to be seated. The user can make a selection via the interface, such as selecting a “cancel” button, to indicate the party doesn't wish to be seated. In response, the action can be cancelled. If a temporary hold has been placed on the seating then the hold can be removed and the system can return the interface to a default state where it is ready to respond to the next event.

In 364, when the user determines the party is ready to be seated, the user can input a confirmation of this determination into the system. In 356, the host can seat the party at the indicated location. In 358, a seating object can be created. In addition, if the seating object shares a seating location with another seating object, then the seating object which shares the seating location can be considered as unavailable by the system. As described above, the seating object can be used for creating a record of historical seating data that can be used to generate estimated wait times and seating durations. The user can either accept the suggested seating location or choose another. For example, to choose another seating location, the interface can be configured to allow a user to drag an entry from the waiting list to an available table in the seating manager graphical representation and ‘drop’ the entry on the chosen table to seat the party at the selected table.

Next, with the respect to FIG. 3B, a workflow for the seating management system is described that starts with the departure of a seated party. In 402, an employee can notice via visual observation that a seated party is leaving and/or their departure is imminent. For example, the employee might see the party has just paid their check, the party is in the process of leaving or an employee is bussing the seating and the seating appears to be empty.

In 404, in response to the determination that the seated party is leaving, the user can access a seating manager component of the system and select a seating which corresponds to the leaving party. In various embodiments, as described with respect to FIGS. 4A and 4B, the seating locations can be displayed graphically and/or textually within the system interface. In 406, the system can determine whether it has a record of the seating being currently occupied. When the system indicates the seating is currently occupied, in 414, the system can prompt the user to unseat the selected seating object which corresponds to one or more seating locations (e.g., see FIG. 5A).

In 408, when system determines no one is currently seated in the selected seating location 406, the system can determine whether the selected seating location is currently on hold. When the system determines in 408 the selected seating location is currently on hold in 408, then the system can return to the interface state in 404 where the system is ready to receive a selection of a seating location. When the system determines in 408 the selected seating location is not currently on hold, then in 410, the system interface can generate a prompt as to whether to seat the location (e.g., see FIG. 5D for an example of a seating prompt).

In 410, the system can be configured to prompt whether to seat the location because the operator may opt to ignore the suggestion. In particular embodiments, the system can be configured to allow the operator to ignore many if not all of the actions suggested by the system. When system allows a user to ignore and/or override seating suggestions, an experienced host or maitre d′ can have the flexibility to doing whatever they wish in regards to seating.

As an example of a user override capability, in one embodiment, a “manual hold” mechanism can be provided with the system. The manual hold mechanism enables sophisticated operators to override the seating workflow suggested by the system. Using the manual hold function, the operator can put a manual hold on any table or seating to override system holds. When specified, the system will ignore any seating with a manual hold and allow the operator to seat or leave them empty indefinitely. The system can be configured to generate an interface that allows a manual hold to be placed and/or removed.

If the selection was unintended, in 412, the interface can be configured to receive an indication that the selection was unintended. For example, a selectable input button with the word “cancel” can be displayed in the interface. From 416, when the user determines the location is not the correct seating location, the user can also select the cancel button. When the cancel button is selected, the interface can return to the interface state in 404. From the interface state 404, the system can be configured to allow the user to select another seating location.

In 418, when the user determines the seating location is correct in 416, the user can select or input via the interface an indicator to inform the system that the seating location is now unoccupied. In response, in 420, the system can store the time of departure in the record of the seating object. The seating object associated with the seating location can then be closed and stored to a persistent data store. The information associated with the close seating object can be used to determine expected seating durations associated with a similar seating object that is generated in the future.

In 422, a new seating object can be created to represent the available seating location. When an establishment first opens, seating objects can be created for each the available seating locations and seating location combinations within the establishment. In 424, the system can execute the hold agent. In 426, the system can determine whether the new seating object can accommodate a reservation that is scheduled to be seated within some near-term time interval.

In 428, when the system determines the new seating object can accommodate a reservation, a hold object can be created. The hold object associates the reservation object with a seating object. The system can periodically determine which hold objects are active and then update a GUI to indicate which seating locations are on hold. In one embodiment, the hold object can be created an assigned a time period. The system can be configured to monitor the elapsed time from when the hold object is created. When the assigned time period is exceeded, the system can be configured to delete the hold object and thus, release the associated seating location or locations that are being held. This situation might occur if the party associated with reservation doesn't arrive within some time period.

In 426, the system can determine the newly created seating object doesn't accommodate an incoming reservation. The seating object may not accommodate an incoming reservation because the seating object may be too small or too large for the reservation or there may not be any incoming reservations. In 430, the system can determine whether the seating object can accommodate a waiting party. The system can represent the waiting party as a waiting list object. In one embodiment, the system can start at the waiting list object at the top of the waiting list and determine whether the first waiting list object can be accommodated by the seating location associated with the new seating object. When the first waiting object can't be accommodated by the new seating object, the system can check the second waiting list object. Thus, the system can proceed checking each waiting list object until all of the waiting list objects have been checked against the new seating object.

When the seating object can't be used to accommodate a waiting party or if there are no waiting parties, the interface can depict graphically and/or textually that the seating associated with the seating object is now available. In 432, when the seating object can be used to accommodate a waiting party, the system can generate a prompt asking the user whether to switch to a waiting list interface component to allow a party on the waiting list to be seated. In 434, the user can determine whether to take the action associated with the prompt. When the user decides not to take the suggested action, in 436, the interface can be configured to accept an indication of this decision. For example, a selectable cancel button can be displayed in the GUI. When the cancel button is selected, the suggested action can be cancelled.

In 438, the system can receive an indication that the user wishes to change to the waiting list subsystem. In response to receiving the indication, in 440, the system can change a state of the interface such that a waiting list component is generated. The waiting list component may allow a user to select a waiting party from the waiting list, such as the one that can be accommodated by the newly created seating object. In addition, the system can generate a prompt that asks whether the waiting party is to be seated at the seating location or seating locations associated with the seating object.

The user can determine whether the waiting party is ready to be seated. If the waiting party is not ready to be seated, the interface can return to 436 where an input indicating not to proceed with the transaction can be made. If the waiting party is ready to be seated, the user can indicate this fact via an input to the interface. For example, in 444, the user can select a selectable graphical button with “OK” to indicate that the waiting party is to be seating in the location associated with the seating object. When the “OK” is selected, the system can store additional information to the seating object. For example, system can store the date, identity of one or more members of a party, time and size of the party assigned the seating locations to its associated seating object. In addition, the user can seat the party at the indicated location such as by walking the party to the location.

Next, with respect to FIG. 3C, a work flow is described that starts when a waiting party that has an associated wait list object leaves before being seated. In 460, a user can determine that a waiting party has left prior to be seated. For example, the user might walk around a waiting area calling a name associated with the waiting party and receive no response. In response to the determination the waiting party is no longer present, in 462, via the system interface, the user can access the waiting list component of the interface (see e.g., FIGS. 5C and 5D). In one embodiment, the waiting list elements associated with each of the waiting list objects can be displayed as rows on the interface. A selectable button can be included in the interface that allows details associated with each of the waiting list elements to be displayed.

In 464, in response to receiving an indication to view details of a waiting list element, the interface can change its state such that a detailed view of the wait list element is displayed. In one embodiment, a selectable “delete” button can be generated in the interface. In 466, the system can receive an indication that the user wishes to delete the waiting list element and its associated waiting list object. For example, a “delete” button generated in the interface can be selected. In 468, the software can generate a prompt that allows the user confirm that they wish to delete the waiting list object.

In 470, the user can attempt to confirm, such as via visual observation, that the party has departed if the party didn't previously inform the user that they were leaving. The user can make the decision in regards to whether the party has departed in 472. In 474, when the user determines the party has not left or the user is not sure the party has left, the user can indicate via the interface not to delete the waiting list object from the waiting list. For example, the interface can display a selectable cancel button and the user can select the cancel button in the interface. In response, the system can return to a previous state. For example, the waiting list objects can again be displayed in rows and details of the previously selected waiting list object can be hidden.

In 476, the user can confirm that they wish to remove the waiting list object from the waiting list. For example, an “OK” button displayed in the interface can be selected to make the confirmation. In 478, in response to receiving the confirmation, the waiting list manager component can receive an instruction to remove the corresponding waiting list object from its list. In 480, the waiting list manager component can mark the waiting list object as deleted. In one embodiment, the deleted waiting list object can be stored for future analysis. For example, a time when the waiting list object is deleted can be recorded and a waiting time can be estimated for the deleted waiting list object. Later, the waiting times for deleted waiting list objects cancelled in this manner can be compared to one another to determine whether the length of the waiting time is the likely cause for the early departure and whether anything can be done to shorten the waiting times in the future.

In 482, the system can determine whether a hold object is associated with the waiting list object. When a hold object is not associated with the waiting list object, then the system interface can return to a default state. For example, the system interface can return to a state where the seating management component is displayed. When a hold object is associated with the waiting list object, in 484, the system can mark the hold object deleted. In 486, the hold subsystem can release the seating location or locations associated with the hold object and an interface showing available seating can be updated to reflect the hold has been removed. In 488, the system can determine whether a location was available to seat the departed party. In 490, when the location was available to seat the departing party (but not used), the system can be configured to assign the location to another waiting party if applicable.

### Seating System GUI

FIGS. 4A-4B show screen shots of seating manager component of a graphical user interface (GUI) for a seating management system. The format of the interface shown in the screen shots is provided for the purposes of illustration only and is not meant to be limiting. In alternate embodiments, additional or fewer components can be shown and the components can be arranged differently.

In 500, a screen shot including a graphical representation of seating components 524 in an establishment is shown. The seating locations can generally correspond to their location in the establishment. If the establishment includes multiple floors or sections separated in some manner, a number of selectable tabs can be included that allow the different floors or sections to be viewed separately. In another embodiment, all of the seating locations can be displayed simultaneously. For example, the seating arrangement for a first floor of restaurant can be displayed next to a seating arrangement for a second floor of a restaurant in a side by side manner.

In one embodiment, the seating components can be color coded or patterned in some manner to indicate whether the seating location is open, occupied or closed. For example, seating locations B1, B2, C2, W1, S2, A5 and A4 can be colored a first color to indicate that the seatings are open, seatings B3, A3 and W2 can be colored a second color to indicate the seating locations are closed and C4, C3, A2, A1 and S1 can be colored a third color to indicate the seatings are currently occupied.

Other relevant information can be shown graphically. For example, an X can be placed through a seating to indicate it is being held by the hold agent. For example, an X is placed through seatings A5 and A4 to indicate they are being held although they currently are not occupied. As described above, the seats might be held for a party with a reservation that is about to arrive or a party on the waiting list.

A box around a group of seating locations can be used to indicate that the seating locations in the box can be combined to seat a larger party. As described above, seating objects can be created for the seating locations alone or in combination with one another. Thus, a seating object can include one or more seating locations. For example, a box is shown around B2, C2, and B1 to indicate these seating locations can be grouped as a single seating location to seat a larger party or can be individually seated. As another example, a box is placed around seating locations A4 and A5 to indicate these seating locations can be seated separately, such as a first party in A4 and a second party in A5, or together as a single seating location, such as a single party in A4/A5 combined.

Other formats can also be used to show information about seating configurations for an establishment. In FIG. 4B, a screen shot 530 is shown where information about the seating locations shown in 500 is presented in a list format. Like 500, color coding can be used to convey seating related information. For example, a circle at the start of each item can be colored or patterned to indicate whether a seating is open, held, or occupied. As shown in 530, this information can also be conveyed in a textual format.

In 530, seatings 532, 534, 536, 538, 540, 542 and 544 are open. Seatings 552, 554, 556, 558 and 560 are occupied. For each of the occupied seatings a remaining seating duration is displayed. When a party is seated at a seating which can include one or more seating locations, an estimated seating duration can be determined and then the system can count down from the estimated seating duration to determine the time remaining. The time remaining provides an indication of how soon a seating is likely to be available. A seating object representing the seating can be instantiated in the system and the estimated seating duration can be stored with the seating object.

A “wait” is associated with seating 550. The “wait” can indicate that the seating 550 has been held for a party on the waiting list. The seating can seat up to six people. It comprises two seating locations 546 and 548. While the system is waiting to seat the larger party, a hold has been placed on seatings 546 and 548. If the party is not seated within some time period, the hold can be released at which point a larger party can be seated or two smaller parties can be separately seated at the seating locations associated with seating 550.

In the previous paragraph, three seating objects can be created from seating locations 546 and 548. A first object can include seating location 546, a second object can include seating location 548 and a third seating object can include seating 550 which is a combination of seating locations 546 and 548. When the third seating location 550 is occupied then neither the first or second seating location 546 or 548 is available. When the first seating location 546 is occupied, the third seating location 550 is not available but the second seating location 548 can be available or not available. When the second seating location 548 is occupied, the third seating location 550 is not available but the first seating location 546 can be available or not available.

When the first seating location 546 is opening up (e.g., party is leaving), then if the second seating location is available, then both the first 546, second 548 and third seating locations 550 can open up as well for a possible seating. However, if the second seating location 548 is not available when the first seating location 546 opens up, then only the first seating location 546 will open up. In this situation, the third seating location 550 can open up if the second seating location 548 opens up before the first seating location 546 is again occupied. In some embodiments, when two seating locations can be combined to form a larger seating location and both seating locations are currently seated to separate parties and one of the seating locations in the combination becomes available, based upon 1) whether a party is waiting that can be seated at the combined seating locations, 2) whether a party is incoming that can be seated at the combined seating locations and/or 3) the expected remaining duration before second seating location in the combination is to open up, the system can be configured to place a hold on the available seating location in the combination to allow the combined seating location to become available.

In the example above, a combination of two seating locations that can be combined is described. In general, two or more seating locations can be combined. For instance, a combination of three seating locations is described herein. For a combination of three or more seating locations, a similar method can be applied in determining whether to hold one or more seating locations in the combination to allow the combined seating location to open up.

In 530, closed seating locations, such as W2, A3, and B3 in screen shot 500, are not shown in the list format. In the list, a number is shown besides each seating object. The number indicates the number of persons that can be seated. For example, the sushi bar 532 can seat up to eight people and B1/B2/C2 when combined can seat 10 people. Separately, B1, B2 and C2 can respectively seat 4, 4 and 2 persons. In this embodiment, the system creates seating objects for the seats in the group individually as well as a group so that the different seating options can be made available.

Returning to FIG. 4A, additional information is shown in screen shot 500. The seating manager 506 can be a selectable button that causes a seating manager component 504 to be displayed to the interface. The waiting list 508 can be a selectable button that causes a waiting list component (see FIGS. 5A and 5B) to be displayed. In screen shot 500, four parties are indicated as being on the waiting list. The reservations 510 can be a selectable button that causes a reservations component to be displayed in the interface (see FIG. 6B).

The maitre d' alerts 512 can be a selected button that causes system alerts to be displayed in the interface. The system can display an alert which can include a selected course of action. As described above, one example of an alert can be that a waiting party's table is being held up because the party occupying the table has not left. In this example, a suggested course of action might be to notify the waiting party and offer them a free appetizer.

Messages can be messages received by the system. In one example, a message can be a voice mail, e-mail or text message from a customer indicating there is change to their reservation. For example, the customer can indicate in message they will not make their reservation, they are running late or the number of persons in their party has changed. In response to receiving the message, a user can adjust information in the system. For example, in response to a message a customer is running late, a user can locate and adjust the party's reservation, such as moving it to a later time.

The guest book 516 can be a selectable button that causes an interface to be generated that allows a visiting customer to provide contact information, such as an e-mail address. In one embodiment, a selection of the guest book can cause a contact list to be displayed. The contact list can be a list of people previously registered in the guest book. The settings 518 can be a selectable button that causes an interface that allows a user to adjust system setting. As an example, a user may be able to specify various system parameters, such as an amount of time that needs to elapse before information from a seating object associated with a seated party needs to elapse before it is counted as historical seating data.

Finally, the system interface can include a current date and/or time, such as 502. In addition, the system can include branding components. For example, Chowtime™ 520 can be a provider of the application that generates the interface. As another example, the restaurant name 522 can be the name of the name of an establishment, such as but not limited to a restaurant where the system is deployed. In one embodiment, via the settings 518, a user can upload and image and input text that can be displayed in 522.

Next, with respect to FIGS. 5A and 5B, prompts generated relating to seating are described. In screen shot 570 of the interface, a user has noticed a party has left a seating location. In response to this observation, via the system interface, the user has selected a seating location. In this example, a party has vacated seating locations A4/A5 and the user has selected these locations. The seating locations A4/A5 have been combined for seating a single party.

In response to the selection of seating locations A4/A5, the system has generated prompt 572. If the system receives a selection of the “OK” button, such as by detecting a touch input on a touch screen, then the seating location A4/A5 can be unseated. If the “Cancel” button is selected then the prompt 572 can be removed from the interface.

As described above with respect to FIG. 3B, after a seating location is unseated, the system can be configured to determining whether the vacated seats can be used to accommodate an incoming reservation or a party on the waiting list. In FIG. 5B, a screen shot 580 is shown after a determination is made by the system that a waiting party can be seated in the vacated seating locations. In response to the determination, a prompt 584 has been output to the interface. The prompt 584 indicates that a waiting party is ready to be seated via a message in a text format.

The prompt 584 gives the user the option of proceeding to the waiting list by a selection of the “yes” button or closing the prompt by selecting the “no” button. If the user accidently selects “no” and closes the prompt, the user can select the waiting list tab 508. A selection of the waiting list tab 508 will also cause the system to output information associated with the waiting list component.

In FIG. 5C, the waiting list component 602 is shown in interface screen shot 600. The waiting list includes four parties displayed on rows, 604, 608, 610 and 612, respectively. Party A includes five people, Party B includes two people, Party C includes one person and party D includes 4 persons. A first indicator, “Ready” is placed on row 604 to indicate party A can be seated. The circles 606 in front of each party can include a pattern or a color to indicate whether a party is ready to be seated. For example, the circle in front of party A can be green to indicate Party A can be seated and the circle in front of Party B can be red to indicate a table is not yet ready for Party B.

In this example, a seating has opened up that allows the first party on the list to be seated. In other scenarios, one or more parties on the list can be skipped when a seating opens up that doesn't meet the seating criteria associated with the first party on the list. For example, if a seating for one person opened up, then Party A and Party B on the waiting list could be skipped. As another example, if a seating for five opened up but it didn't meet some seating criteria specified by Party A, such as having a scenic view, then Party A, Party B and Party C can be skipped and Party D could be seated at the location.

In FIG. 5D, which shows screen 620, the user has selected Party A on the waiting list. In response to the selection, the row 604 showing party A is highlighted. In addition, a prompt 624 is output to the display. The prompt 624 includes the text message “Seat Party at A 4/5?” When the user selects “OK,” then the system can seat the party at the location in its record and update the system such that the Seat A 4/5 is shown as occupied in the seating manager component of the interface. If the “Cancel” button is selected, then the prompt 624 can be removed from the interface.

FIGS. 6A and 6B show screen shots of the effect of an incoming reservation on the seating management component of the GUI. In FIG. 6A, screen shot 630 is shown. A graphical layout 636 is provided of the seating locations and their current status. In this example, seating locations A4 and A5 are closed, C4, A3, A2, S1 and W2 are occupied and B3, C3, B2, C2, B1, A1, W1 and S2 are open. In response to incoming reservation, the system has placed seating locations on hold. The system may have placed the seating locations on hold because the reservation is supposed to arrive in the next 5 minutes or the next 10 minutes. For example, for 7:00 PM reservation, the system can be configured to determine whether any seating locations are available at 6:50 PM and then hold the tables. In another example, the system can proceed based upon the workflow shown in FIG. 3A starting with the arrival of a party with a reservation in 302.

In FIG. 6B, reservation information is shown in screen shot 640 of the interface. In one embodiment, the user can view times that are reserved by selecting button 642 or times that are available for a reservation by selecting the button 644. In 640, a selection of the row 646 including date may allow the user to select different dates and view the reservations according to a selected date. In one embodiment, the user can select row 648 corresponding to the reservation to Party for three people at 7:00 PM. In response to a selection of row 648, the system can determine whether one or more seating locations are available to seat the party. In this example, the system has determined that the party can seated at the seating location B3 and C3 when the two seating locations combined.

In response to the determination that Party A of three can be seated, the system has generated a prompt 650 in the interface. The prompt includes the text message, “Table Ready.” In addition, the prompt 650 includes the question “Seat Party A at B/C 3 now?” The interface allows the user to make one of two inputs. The user can select and “OK” button to seat Party A at the indicated location in the system or select “Cancel.” A selection of the cancel button can cause the prompt 650 to be removed from the system interface.

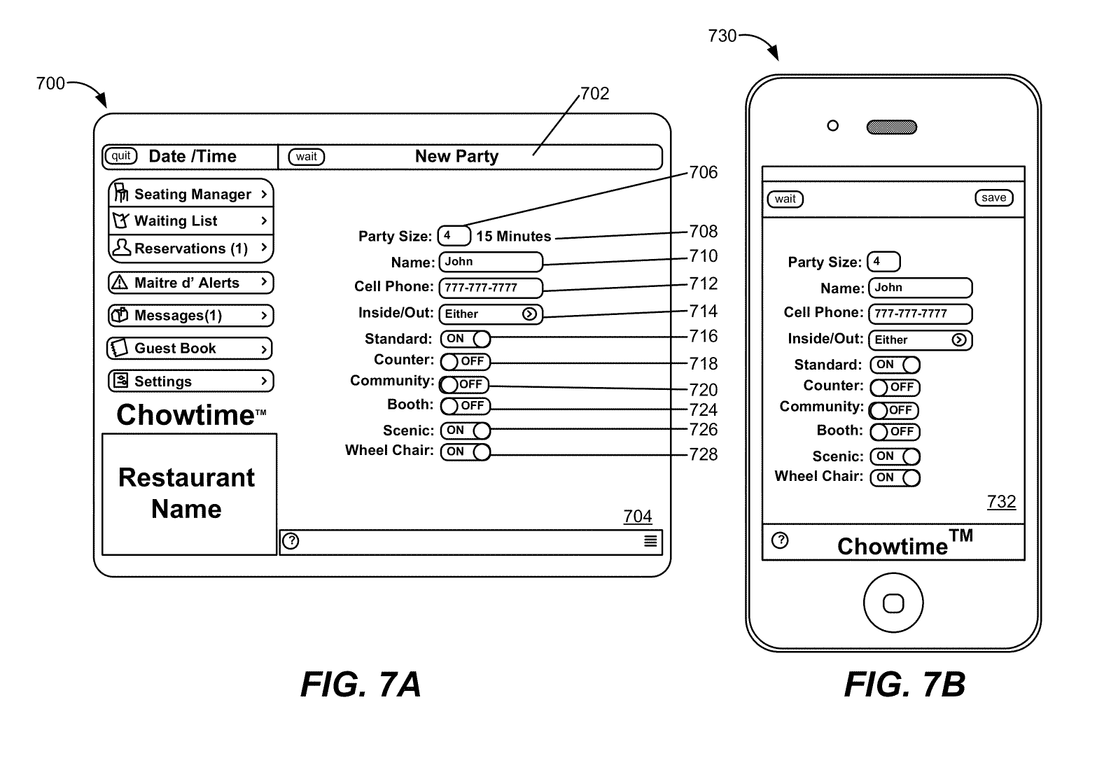

FIGS. 7A-7B show screen shots of a GUI of a seating manager component that allows for specifying information about new parties in a seating management system. The GUI 700 may allow a user to input and/or select information related to seating a new party 702 on screen 704. In a particular embodiment, the user can input and/or select a number of seating parameters including but not limited to i) a party size 706, ii) a party name 710, iii) a cell phone number 712, iv) inside, outside or either seating location 714, v) standard/non-standard seating 716, vi) counter seating 718, vii) community seating 720, vii) booth seating 724, viii) scenic seating 726 or ix) wheel chair compatible 728. The seating parameters can indicate seating options that are acceptable to a user.

In the example of FIG. 7A, the specified party size is four and either inside or outside seating has been selected. In addition, standard, scenic and wheel chair seating has been selected. However, counter, community or booth seating is turned off. These parameters are selected by adjusting a position of a slider. Based upon the selected seating parameters, a current occupancy of the venue and/or a seating history data, a waiting time, such as 708, can be determined and output to the display screen 704. When the combination of seating parameters is changed (e.g., counter seating is turned on and the party size is changed), the estimated waiting time 708 can change.

One example of determining an estimated wait time is as follows. First, a number of parameters that can be used to determine an estimated duration for a table seating can be specified. These parameters can be used in different combinations with one another as is described in more detail below. As an example, a selection parameters that can be utilized to estimate wait time to receive a seating include but are not limited to a party size, a day of the week (e.g. “MON”, “TUE”, “WED”, . . . ), a shift (e.g. “LUNCH”, “DINNER”), a time of day, a section name (e.g. “INSIDE”, “OUTSIDE”), and a particular table which can be represented by an identifier. In another embodiment, as is described below, a time interval can be used instead of shift or in conjunction with shift.

Other combination of parameters can be utilized. For example, as described above, seating parameters, such as booth, counter or scenic/not scenic can also be employed. Thus, the combination of seating parameters including party size, a day of week, a shift, a time of day, a section, a server skill, a server busyness and a particular table, are for the purposes of illustration only and are not meant to be limiting.

After a combination of seating parameters, which can be varied to determine estimate wait time, are specified, in one embodiment, a history window can be specified. For example, sixty days can be specified. The assumption in selecting the length of the history window is that at all history may not be used, just recent history, because staff turnover and process/efficiency changes in the structure of the business will change performance of the restaurant over time. Thus, past seating data related to the duration of a seating may not be likely to predict current performance after a certain time period has elapsed.

Next, values stored in a lookup table structured as follows in a database language such as SQL can be created for the purpose of estimating wait time. In the first step, at least once every 24 hours, it can be determined whether the algorithm has not been run within 24 hours or the system has been idle for over some threshold time, such as idle for six hours. When one of these conditions is met, the system can initiate the algorithm used to estimate seating durations by handling seatings left in an “open” state. For example, the hostess may have gone home at the end of a shift with tables still marked “seated.”

In one embodiment, for each seating left in an “open” state, the system can be configured to mark the seating ended using a turn estimate generated by the algorithm. The turn estimate is related to how often the seatings “turn” over. For each seating left open and treated in this manner, the system can mark the seating's duration value as an “estimate.” When a turn estimate is made in this manner, they can be used to compute averages and standard deviations as described below. In another embodiment, data associated with seatings in an open state can be thrown out and not used by the system.

Next, a lookup table populated using specific values of the parameters specified above can be cleared. The data may be cleared because the values used to populate the lookup table may have changed. For example, the lookup table may have been populated according to historical data associated with Tuesday. The next day, the lookup table can be cleared because it is now Wednesday and the wait times for Wednesday may be different than Tuesday.

After the lookup table is cleared, various combinations of the specified parameters within the history time period can be generated. This can be expressed as an SQL query: SELECT DISTINCT SIZE, DAY, SHIFT, TIME OF DAY, SECTION, LABEL FROM SEATING WHERE NOT ESTIMATE AND TIME>NOW−WINDOW where distinct size is the party size, day is the day of the week, shift is the shift (e.g., lunch or dinner) time of day is range of time represented by a start time and an end time and label refers to a particular table and window is the history time period.

Next for each row returned in the previous paragraph, a look up key value for the table can be generated, “Key”. In one embodiment, a string can be created from the values returned by concatenating the components of the string. For example, the “key” could be KEY=“4_MON_DINNER_{—}9:00 PM_{—}9:30 PM_PATIO_TABLE-2,” or KEY=“8_THU_LUNCH_{—}12:30 PM_{—}1:00 PM_INSIDE_BAR” or the KEY=“3_FRI_LUNCH_PATIO_TABLE-4.” In the first key example, 4 is the party size, Monday is the day of the week, dinner is the shift, 9:00 PM to 9:30 PM is the time of day, patio table is the section and 2 is the particular table on the patio. Next, for each of the matching rows for the combination of parameters, a sum of durations, a seating count, an average duration and a deviation can be determined. The average can be defined as the sum of durations divided by the seating count. The deviation can be a standard statistical deviation from the mean, such as “deviation=square root of (SUM((DEVIATION−AVG)̂2)/SEATING_COUNT).” The determined values of the average and the deviation can be stored for each key value.

The process described above can be repeated for different combination of parameters. For example, the steps above can be repeated when the exact tables in a section are not included in the combination of parameters used to determine the key values in the lookup table. Examples of the key values for this remaining combination of parameters can be “4_MON_DINNER_{—}9:00 PM_{—}9:30 PM_PATIO,” “8_THU_DINNER_{—}6:30 PM_{—}7:00 PM_INSIDE”, “3_FRI_LUNCH_{—}1:30 PM_{—}2:00 PM_PATIO.” Thus, party size, day of the week, shift, time of day and section are specified in the combination. Again, for these key values, an average duration and deviation can be determined and stored to the lookup table according to these key values. As another example, the steps above can be repeated when the section and the exact tables in a section are not included in the combination of parameters used to determine the key values. Examples of key values for the remaining parameters in this combination of parameters can be “4_MON_DINNER9:00 PM_{—}9:30 PM,” “8_THU_DINNER6:30 PM_{—}7:00 PM,” and “3_FRI_LUNCH1:30 PM_{—}2:00 PM.” Yet again, for these key values, an average duration and deviation can be determined and stored to the lookup table according to these key value combinations.

In yet another example, the steps above can be repeated when the section, the section and the exact tables are ignored or all the parameters accept the sizes are ignored. Key values can be determined, such as table size and day of the week or just table size. Again, an average and a standard deviation from the average can be determined for historical data matching the specified combination of parameters in the key value. The determined average value and deviation from the average can be stored to the look up table. In general, the look up table can be populated according to all or a subset of the combination of key values listed above where the parameters used for the combinations are for the purposes of illustration only and are not meant to be limiting. For example, a parameter, such as holiday could be added to account for seating durations during holiday periods.

When the lookup table is populated, to estimate wait duration, a series of values can be entered and a key value for the lookup table can be determined. For instance if a party number, day of the week, shift and time of day is entered, the key value can be determined and an associated value from the lookup table can be retrieved. As another example, if a table ID, day of the week, shift, time of day and party size is entered, then a key value can be determined for these parameters and values from the lookup table corresponding to this combination of parameters can be returned. In particular embodiments, shift and time of day can be each used alone or in combination with one another.

In one embodiment, the estimated wait time can be determined as the average value returned plus some multiplier times the deviation returned. For example, the multiplier might be one, two or three times the deviation determined. Other estimates might also be used. For example, rather than deviation from the average, a deviation from the mean could be used. Thus, this example is provided for illustrative purposes only and is not meant to be limiting.

In another embodiment, instead of using a shift identifier (i.e. “lunch”/“dinner”) to form the keys which are used to store and look up table turn statistics, the system can be configured to use an integer identifying the 15 minute interval (out of 96 total in a 24 hour period) when a party is seated. For example, one represents midnight-12:15 am, two represents 12:15 am-12:30 am, three represents 12:30 am to 12:45 am and up to ninety six which represents 11:45 pm-midnight. With this implementation, variations which occur within a shift can be captured. For example, a restaurant located close to a movie theater may have shorter table turns about forty five to sixty minutes before movies start, but longer table turns between movies. These dynamics can be captured using the integer values described above. Other intervals are possible and fifteen minutes is provided for the purposes of illustration only.

In one embodiment, four “keys” can be used to store and look up statistics. Thus, for each potential or recorded table turn, four attributes can be examined to compose the keys: i) SIZE: the size of the party, ii) INTERVAL: integer representing the 15 minute interval when the party was/is to be seated, ii) WEEKDAY: integer representing the day of the week. Sunday=1, Saturday=7, iv) TABLE: unique record id for the particular table. As an example, the four keys which would be composed for a party of two people seated or to be seated at Table eight at 6:20 pm on a Thursday can be i) 2.66.5.8, ii) 2.66.5, iii) 2.66 and iv) 2 where 2 represents 2 people, 66 is the 66th 15 minute interval in the 24 hours period (6:15-6:30), 5 represents Thursday and 8 which is assumed to be the record id for Table 8 (which happens to match the label but could be any integer).

When calculating statistics, the system can be configured to examine every seating recorded in the past for a number of days determined by a parameter (CALCULATION WINDOW). In one embodiment, the default value for this parameter can be 90 days. However, it can also be a user modifiable configuration setting.

The table stats can get recomputed daily to allow the system to adjust the estimates it generates since restaurant usage patterns can vary seasonally. In one embodiment, the result of the statistics calculations may be a database table storing records with the following structure (expressed with C syntax where all time values are stored as the number of seconds).

{

| | |
|---|---|
| char *key; | // unique key (see below) |
| float average; | // average turn time for key |
| float deviation; | // standard deviation for key |
| float count; | // number of samples |

}

When calculating statistics for a seating with a given duration, the tuples matching all four keys can be updated. If a row does not exist, then, in one embodiment, it can be initialized with all values set to zero. In other embodiments, a non-zero default value can be used. Each row corresponding to one of the four keys can updated as follows (again with C syntax where all values can be stored as floating point numbers): {average=(count*average+duration)/(count+1); and deviation=sqrtf((count*powf(deviation, 2)+powf(abs(duration−average), 2))/(count+1)); count=count+1;}.

In one embodiment, the database table can be indexed on “key” for lookup efficiency. To generate a table turn estimate, the system can be configured to compose the four keys, described above, and search for a matching tuple in order from longest to shortest keys. A tuple can be deemed to be a match if the count is larger than a MINIMUM_SAMPLE_SIZE. The minimum sample size can be hard coded as some value, such as 10, but can also be user configurable parameter.

Returning to, FIGS. 7A-7B, the GUI can be implemented on different types of devices. For example, in FIG. 7A, the GUI is implemented on a device with a first display size, such as an iPad tablet computer (Apple, Cupertino, Calif.). In FIG. 7B, the GUI is implemented on a device with a second display size, such an iPhone (Apple, Cupertino, Calif.). The format of the GUI can be adjusted to fit the different display sizes. For example, the GUI elements related to the seating manager, waiting list, reservations, etc. on the left side of the GUI in FIG. 7A have been removed in FIG. 7B to fit the smaller display size of the device in FIG. 7B.

In a particular embodiment, the devices shown in FIGS. 7A and 7B may be tethered to another in some manner. For example, the device with the first display size in FIG. 7B can be tethered to the device in FIG. 7A or vice versa. Tethering refers to connecting one device to another. In the context of mobile phones or internet tablets, tethering allows sharing the Internet connection of the phone or tablet with other devices. Connection of the phone or tablet with other devices can be done over wireless LAN (Wi-Fi), over Bluetooth or by physical connection using a cable for example, through USB. If tethering is done over wireless LAN, the feature may be branded as a mobile hotspot. The Internet-connected mobile device can thus act as a portable wireless access point and router for devices connected to it.

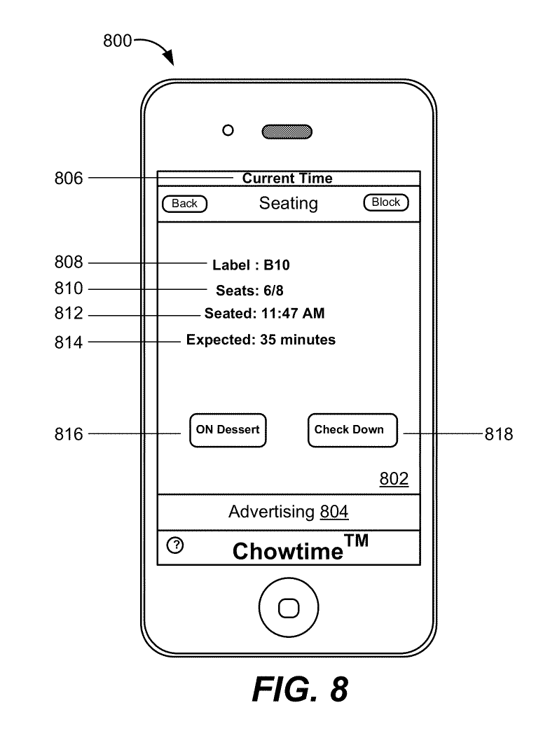

FIG. 8 shows a screen shot of seating manager component of a graphical user interface (GUI) for a seating management system that allows a user to input updated seating estimate data implemented on a portable electronic device 800. Similar to the methods described above, such as by using historical data, the system can be configured to estimate a time that a seating is expected to be occupied. For example, the system may calculate an average seating time and then a standard deviation based upon historical data to estimate how long it expects a seating to be occupied. For any number of reasons, the estimate may not be accurate and may be exceeded for some reason. For example, the party at the seating may simply be taking a long time or there may have been problems in getting the party's food out.

When a seating is being occupied for a period that is longer than is expected, the system can be configured to allow a user to supply information that allows a seating estimate to be updated. In FIG. 8, an interface is implemented on a smart phone with a display 802. In one embodiment, a host can be notified when an estimated seating time has expired or is about to expire without an indication that the seating has opened up. In one instance, the time may have expired without the system receiving an indication that the seating is now open. The host may have simply neglected to input information indicating the seating is open. In response to the notification, the host can observe that the table is open and update the system.

In another instance, the seating estimate may have been exceeded and the table may still be occupied. In response to the notification that the seating estimate has been expired, the host can observe that the seating is still occupied and can attempt to assess a state of the seating. For example, the host can attempt to determine whether the main course has been cleared and the occupants are eating dessert. The system can be configured with an option that allows information related to a state of the seating to be input. Based upon this information, a new estimate for seating duration can be made. In general, this interface can be brought up if the host notices that something about the seating is not normal, such as events occurring faster or more slowly than normal for a particular seating

As an example, in FIG. 8, an interface is output to display 802 on device 800. The interface includes a current time 806 and information about a particular seating. In particular, a seating label 808, a number of seats 810, a time that the seating started 812 and an estimated seating duration 814 is output to the display. In this example, the label is B 10, the seats associated with the table are 6/8, the time the seating began was 11:47 am and an expected time is 35 minutes. In one embodiment, the expected time can be the estimated time remaining for the seating.

Two options are provided that allow a host to enter information about the state of the seating. These options are provided for the purposes of illustration only and in other embodiments the interface can be configured to receive more or less seating state information. In one embodiment, the interface can receive a selection of the “On dessert button 816.” A selection of this button can be used to indicate the seating is currently engaged in eating dessert or has ordered dessert. In response to receiving this selection, the system can generate a new estimate of how long it is expected the seating will be occupied. For example, when the on dessert button 816 is selected, the expected seating duration 814 might change from 35 minutes to 15 minutes.

In another embodiment, the check down button 818 can be selected. A selection of the check down button can be used to indicate that the party at the table has received a check for their bill. In response to receiving this input, the system can again generate a new estimate of the seating duration. For example, when the check down button 818 is selected, the expected seating duration 814 can be changed from 35 minutes to 5 minutes. In yet another embodiment (not shown), the interface may allow a host to manually input an estimate of a remaining time for a seating duration. The estimate can be based upon their professional knowledge and their current assessment of the operating state of the restaurant.

An advertisement 804 is shown output to the display. In one embodiment, the system can be configured to push various advertisements to the display. The advertisements can be used to fund the cost of the application. For example, the application can be given away for free or a reduced price but then revenue for using the application can be generated when advertising is output.

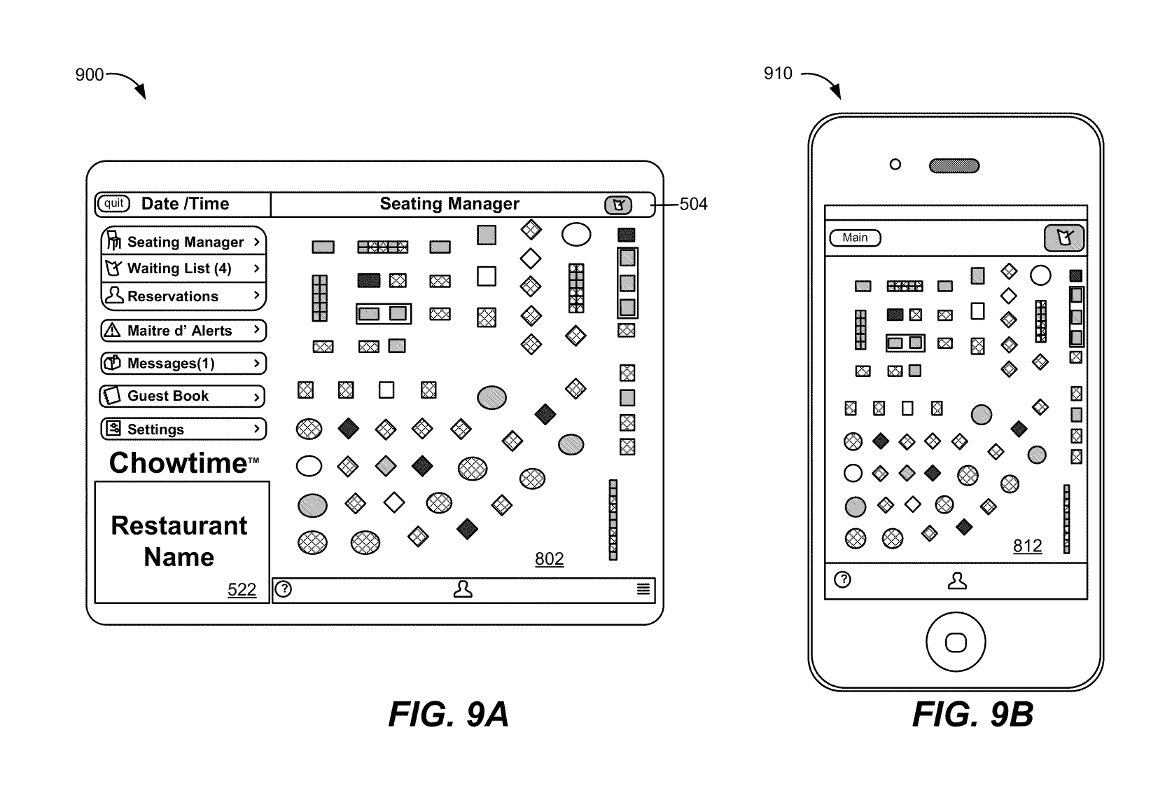

FIGS. 9A-9B show screen shots of seating manager component of a graphical user interface (GUI) for a seating management system in accordance with the described embodiments. In FIGS. 9A and 9B, a more complex seating arrangement is illustrated as compared to the seating arrangement previously described, such as with respect to FIG. 4A. In FIG. 9A, a GUI 900 for a first device, such as a tablet computer, with a first display 902 of a first size is illustrated. In FIG. 9B, a GUI 910 for a second device, such as a smart phone, with a second display 912 of a second size is illustrated. Less information is included in the GUI 910 for the device with the smaller display as compared to the GUI 900 for the device with the larger device. In one embodiment, as previously described these devices can be tethered to one another in some instances.

FIG. 10A shows a screen shot 920 of a seating manager component and an alert component of a graphical user interface (GUI) for a seating management system in accordance with the described embodiments. As described above with respect to FIGS. 2 and 4A, the system can provide alerts as well as possible ameliorative actions. In FIG. 10A, three of the four alerts are mapped to a seating configuration as shown in interface state 920 because the alerts are associated with seated parties. In particular, Alerts 924, 926 and 928 are associated with seated parties. The seated state of the parties is indicated by the chair icons. Alert 930 is associated with a waitlisted party. The waitlisted state of the party is indicated by the waitlist icon. Since alert 930 is not yet associated with a party at a seated table, it is not shown on the seat map.

A party identifier, such as a name, a number of in the party and a time is displayed for each alert. The information displayed for each alert is illustrative and is not meant to be limiting. For example, the alert may indicate that the party is associated with a preferred, frequent or new customer. With this information, an employee may attempt to implement different solutions depending on how the customer has been identified by the system. In one embodiment, a selection of one of the alerts can cause the system to display additional information.

In FIG. 10A, the times in alerts 924, 926 and 928 indicate that the parties have stayed beyond a determined seating time threshold value by an amount of time, such as by eight minutes, five minutes and two minutes, respectively. The determined seating time threshold value can be an estimated seating duration determined by the system plus and additional amount of time, such as but not limited to zero to thirty minutes, or plus some fraction of the estimated seating duration, such as zero to twenty-five percent. When the determined seating time threshold value is exceed an alert can be triggered. In one embodiment, the additional amount of time which can be added to the estimated seating value can be based upon user selected parameters, such as an input fixed amount of time to add or a selected fraction of the estimated seating duration.

Alert 930 is associated with a party on the waiting list. In this example, a wait time threshold value has been exceeded which can cause an alert to be triggered. For example, the wait time threshold value can be an estimated wait time initially determined plus some additional amount, such as but not limited to zero to twenty five percent of the estimated time or a fixed amount of time (e.g., zero to forty five minutes). The system can be configured to choose a default value and receive inputs which allow these values to be adjusted. In 930, the wait time threshold value is exceeded by one minute and an alert is triggered.

Alerts 935 and 945 are associated with a reservation. The alerts, such as 935 and 945 may be triggered because a reservation threshold value is exceeded. The reservation threshold value can be the reservation time plus some additional amount of time, such as zero minutes to an hour. In one embodiment, the reservation threshold value can be dependent on the identity of an individual associated with the reservation. For example, for a VIP customer, a seating object may be held longer than for a non-VIP customer. In some instances, for a VIP, a reservation threshold value may not even be applied.

In FIG. 10A, for Alert 935, the reservation threshold value is exceeded by one hundred thirteen minutes. For Alert 945, the reservation threshold value is exceeded by thirty eight minutes. In one embodiment, an ameliorative action can be suggested with the Alerts. For example, the system can display contact information associated with the reservation and suggest a user contact a person associated with the reservation, such as call, text or email the person. In one embodiment, the system can be configured to automatically contact the person associated with the party. In another example, the system can suggest releasing a seating object associated with the reservation so that it can be made available to another party. In yet another example, the system can suggest assigning a new seating object to the reservation and releasing the seating object currently assigned to the reservation. In yet other examples, for the reservation alerts and other types of alerts, the system can display an alert but not suggest any ameliorative actions.

In particular embodiments, alerts can be mapped to a seating layout output via the seating manager. In 920, the seating manager includes a seating layout 925. The seating layout 925 includes counter space 938, a chef's table 940 and additional tables, such as 932, 934 and 942. As described above, the seating locations can be represented as a number of seating objects which can be assigned to different parties where two or more seating objects can include the same seating location.

In 925, an X or a small circle at a seating location indicates the seating object associated with the seating location is being held. For example, circles are shown at the counter space 938 or the chef's table 940. In this example, seating objects 932, 934 and 936 associated with the alerts 924, 926 and 930. In one embodiment, a selection of one of the alerts can cause some change in seating manager 925 or a selection of one of the highlighted seating objects can cause a change to the alerts. For example, a user can touch an alert or seating object displayed on a touch screen or select it with a cursor to trigger the change. The change that is triggered can allow a user to see which alert is associated with which seating object.

In 925, additional information about a state of a seating object associated with an alert is shown in two instances. This information can also be shown for seating objects not associated with an alert. In one example, a slice of cake 944 on seating object 934 is used to indicate the party at the table is eating dessert. In another example, a dollar icon 946 is displayed to indicate the party at seating object 946 has received a check. Other icons can be used to indicate other stages in a seating, such as but not limited to waiting to order, ordered but food not delivered, food served, etc. When a system user is finished viewing the alerts, the home button 922 can be selected to return the interface to a home state.

Next, a drag and drop feature associated with the interface is described. FIG. 10B shows a screen shot 960 of a seating manager component and waiting list component of a graphical user interface (GUI) for a seating management system in accordance with the described embodiments. Five parties, 952, 954, 956, 958 and 960, are shown on the waiting list. For each of the parties, for the purpose of illustration, a party size, an identifier (e.g., a name), a waitlist icon and status information is shown.

The status information can indicate information such as but limited to a remaining time to be seated, an amount time past a threshold value, the party is ready to be seated or the party has been skipped. For example, party 952 has 11 minutes of their estimated wait time remaining and party 960 has 32 minutes of their estimated wait time remaining. For party 954, their estimated wait time has exceeded a threshold value and an alert is associated with the party as described above with respect to FIG. 10B. Party 956 has been skipped. Party 956 may have been skipped because an available table meeting their party size doesn't meet some criteria specified by party 956 or all of the members of party 956 have not arrived yet.

Party 958 is indicated as being ready to be seated. As described above, the seating manager can be configured to display a number of seating objects which satisfy the seating requirements of the party. For example, the satisfactory seating objects can be indicated via color highlighting. In one embodiment, to select an instantiate a seating object for the party the interface can be configured to allow a user to select and drag an object from one location to another within the interface. For example, a user can select party 958 and drag it to a seating object in the seating manager layout 925. Alternately, the user can select a seating object and drag it to the portion of the display including the party 958. When the seating object and party are brought together one can be associated with the other such that an active seating is created.

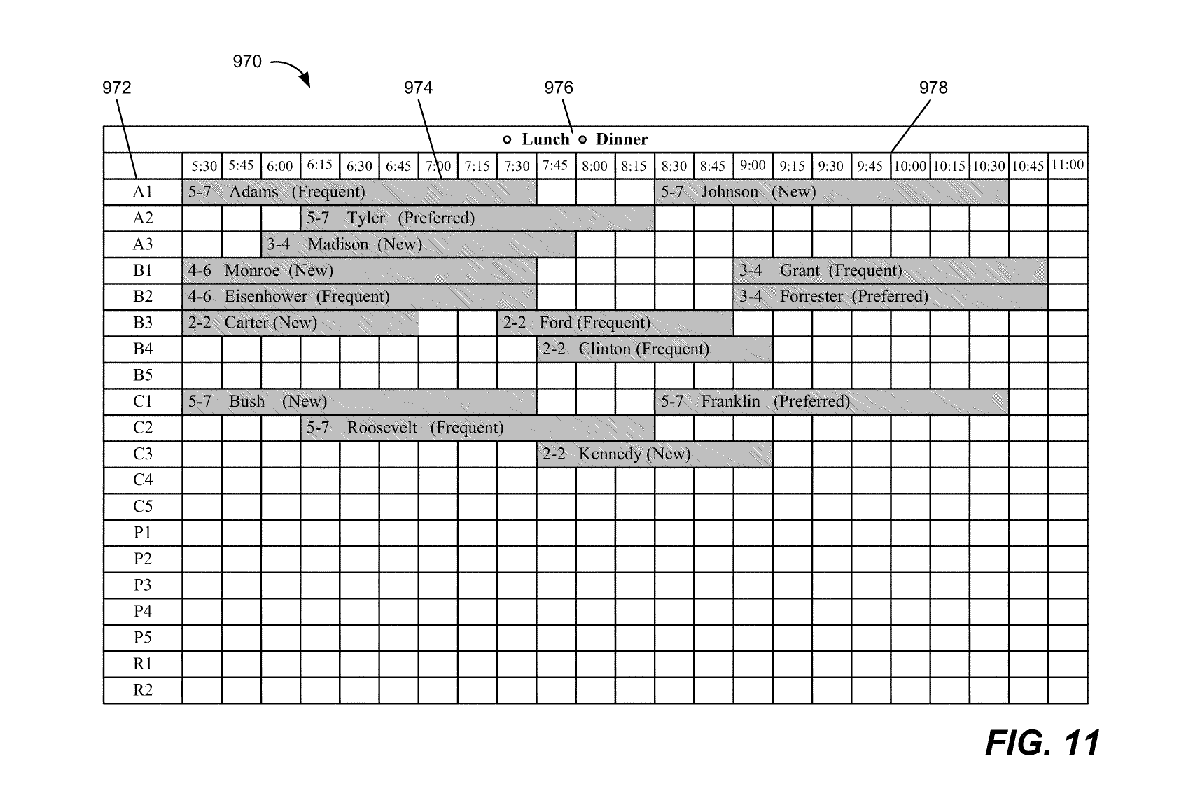

Next, with respect to FIG. 11, an alternate interface configuration for managing seating reservations is shown. FIG. 11 shows a screen shot 970 of a reservation manager component for one state of a graphical user interface (GUI) for a seating management system in accordance with the described embodiments. The interface configuration includes seating objects, such as A1, A2, etc. in a first column 972. On a first row, times are displayed. In this example, a dinner time period with times from 5:30 pm to 11 pm is displayed at 15 minute intervals. The fifteen minute interval is for illustrative purpose only and the system can be configured to use different interface, such as 5 minutes, 10 minutes, 20 minutes or ½ hour intervals.

A selection of another time period can cause the interface to display different times. For example, selecting the lunch button can cause the interface to display times associated with lunch, such as but not limited to from 11 am to 3 pm. The seating objects associated with selected time periods can be the same or different. For example, the same seating objects can be available for lunch and dinner. In another example, the seating objects available for lunch can be different than the seating objects available for dinner.

Reservations, available seatings, seatings on hold, active seatings and/or seatings which have completed can be represented as bars in FIG. 11. In one embodiment, these interface components can be represented by bars with different colors or shading. The length of the bar represents a time period associated with the seating.

In one embodiment, information about the seating can be displayed on the bar. For example, a party size or seating object size, a party identifier (e.g., a name) and a customer type is displayed in each bar. In this example, three customer types are designated: preferred customer, frequent customers and new. A preferred customer can be a high spender, a friend of the owner or a celebrity. A frequent customer can be someone that has returned to the venue a number of times over some time period and has been identified by the system. A new customer can be someone on which the system doesn't have information. Other customer types and criteria for specifying a customer type can be designated and these are provided for illustrative purposes only and are not meant to be limiting.

In one embodiment, customers can join a frequent dining club and be assigned a unique identifier. The unique identifier can be encoded on a card or some other type of token. For example, the unique identifier can be encoded and printed on a magnetic striped card. As another example, the token can be stored on a user's portable electronic device, such as in a bar-code, QR code or text format. The user can provide their unique identifier in some manner to allow their visit to be recorded. For example, the user can present a mag-striped card which can be read by a mag-stripe reader to allow the system receive their unique identifier.

For reservations, the system can be configured to specify an estimated seating duration. The estimated seating duration can be determined from historical seating data and can vary from seating object to seating object and according to the time of day. In one embodiment, the estimated seating duration can even be customer specific. For example, some users may take longer than others and the system can be configured to determine an estimated seating duration based upon historical data associated with a particular individual. The interface can be configured to allow a user to adjust the estimated seating duration, such as to make it smaller or larger. For example, the user can add some fixed amount to the estimated seating duration.

In one embodiment, the estimated seating duration can be adjusted during a seating. For example, an initial estimated seating duration can be determined when a party is first seated. Then, after the party orders the estimated seating duration may be adjusted based upon their order. For example, if a party orders appetizers and a main course, the estimated seating duration can be adjusted upwards as compared to a party which only offers a main course. In other example, if a party orders certain types of foods, such as certain dishes which take longer to prepare, the estimated seating duration can be increased.

In particular embodiments, the interface can be configured to allow a user to adjust the starting point of a future seating (reservation) by moving the starting point of the bar. In addition, the interface can be configured to allow a user to drag a reservation to different seating objects, such as from A1 to C4, etc. In one embodiment, the system can be configured to provide suggestions for rearranging the reservations. For example, the system can display one or more bars being moved from one seating object to another seating object to improve a seating efficiency.

In yet other embodiments, a waiting list can be displayed in a split screen manner (e.g., see FIG. 10B) with the chart shown in FIG. 10C. The system interface can be configured to allow a party on the waiting list to be dragged to the chart to assign a seating object to the party. Further, if the party is assigned a seating object using the seating manager with waiting list as shown in FIG. 10B, the chart in FIG. 10C can be automatically updated to reflect the assignment of the seating object.

In a particular embodiment, the system can be configured to overbook. For example, if four seating objects with non-shared tables are available at a certain time, the system can be configured to allow the system to accept reservations for more than four parties. In this situation, one or more reservations may not be associated with a seating object. The system can be configured to display this information in some manner. For example, in FIG. 10C, one or more rows with a title, such as overbooks can be displayed on the chart. Parties with reservations but without an assigned seating object can be displayed on these rows.

When there is a no-show for one of the time periods that are overbooked or a seating object opens up for some other reason, a party in an overbook row can be dragged to the seating object which has opened up to associated the party with the seating object. In one embodiment, a no-show section, such as no-show rows can be provided. When a party with a reservation is a no-show, it can be dragged to the no-show section to allow the system to track the no-shows. In one embodiment, an occurrence of a no-show can be associated with a member of the party.

In a particular embodiment, an action performed on one bar can trigger additional actions which cause other bars to be automatically rearranged in some manner. For example, shifting one reservation to a later time period, such as the Adams reservation in row A1, can cause the Johnson reservation to also be shifted by some amount, such as to a later time period. As another example, a party may request a reservation for a particular time where none are available and thus, may be given a later time (e.g., the Ford party may have requested the Carter time slot in row B3). Later, a suitable seating object may open up at the desired time. For example, a user may remove the Carter reservation because a member of the Carty party cancelled it. In response, the Ford party can be automatically moved into the Carter spot and then the Ford party can be notified.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, flash memory, magnetic tape and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents. While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A non-transitory computer readable medium having stored a computer program used by a computer, the computer program executed by the computer to provide seating services in an establishment, the computer readable medium comprising:
computer code for receiving information related to a plurality of seating locations in the establishment;
computer code for receiving a designation of a plurality of seating objects wherein each of the seating objects includes at least one seating location and wherein two or more seating objects can share an identical seating location;
computer code for receiving a reservation for a party including a party size and a reservation time;
based upon at least the party size, the reservation time and any seating objects among the plurality of seating objects previously reserved proximate to the reservation time, computer code for selecting a first seating object among the plurality of seating object to associate with the reservation;
proximate to the reservation time, when the first seating object is determined to be occupied, computer code for predicting a first amount of time remaining before the first seating object will become available;
when the first seating object is determined to be available and a current time is before the reservation time, computer code for marking the first seating object as being held to prevent another party from being seated at the first seating object;
when the first seating object is determined to be available, computer code for receiving input indicating the party is seated at the first seating object; and
after the party is seated at the first seating object, computer for predicting a second amount time remaining before the first seating object will become available.

2. The computer readable medium of claim 1, further comprising computer code for determining a second seating object shares the identical seating location with the first seating object and for marking the second seating object as unavailable.

3. The computer readable medium of claim 2, after the first party is seated, further comprising, computer code for determining the first seating object is available and based upon the determining the first seating object is available, marking the second seating object as available.

4. The computer readable medium of claim 3, further comprising computer code for seating a second party at the second seating object and marking the first seating object and the second seating object as unavailable.

5. The computer readable medium of claim 2, wherein the first seating object seats a larger party than the second seating object or the second seating object seats a larger party than the first seating object.

6. The computer readable medium of claim 1 wherein the reservation for the party further includes an identity of at least one member of the party and wherein the first seating object is selected based upon the identity.

7. The computer readable medium of claim 1, further comprising computer code for ranking each of the plurality of seating objects relative to one another.

8. The computer readable medium of claim 7, further comprising computer code for receiving an identity of at least one member of the party wherein when the identity is received, the first seating object which is selected is ranked better than the first seating object which is selected when the identity is not received.

9. The computer readable medium of claim 1, further comprising computer code for receiving a customer type wherein the customer type is associated with the identity and wherein the customer type is used to select the first seating object.

10. The computer readable medium of claim 1, further comprising computer code for receiving one or more seating preference parameters wherein the first seating object is selected based upon the seating preference parameters.

11. The computer readable medium of claim 10, wherein the seating preference parameters include one or more of indoor seating, outdoor seating, window seating, a booth, a private table, a shared table, a counter seating, wheel chair accessible seating or a particular table.

12. The computer readable medium of claim 1, further comprising computer code for receiving when the party arrives at the restaurant one or more of a change in the party size specified in the reservation, a change in the reservation time specified in the reservation, a change in one or more seating preference parameters specified in the reservation or new seating preference parameters not specified in the reservation and based upon the changes or the new seating preference parameters, computer code for selecting a new seating object different from the first seating object.

13. The computer readable medium of claim 12, further comprising computer code for predicting an amount of wait time before the new seating object is available.

14. The computer readable medium of claim 12, further comprising computer code for receiving an indication the new seating object is accepted and computer code for releasing the first seating object so that the first seating object is available for seating.

15. The computer readable medium of claim 1, further comprising computer code for receiving inputs, including a party size and/or one or more seating preference parameters, associated with a second party which has arrived at the establishment without any reservation and based upon the party size and one or more seating preference parameters, computer code for selecting a second seating object for the second party in accordance with the received party size and/or the received one or more seating preference parameters.

16. The computer readable medium of claim 15, further comprising computer code for predicting an estimated wait time before the second seating is object becomes available, computer code for adding the second party to a wait list, for computer code for counting down from the estimated time to determine a remaining time and computer code for outputting the remaining time.

17. The computer readable medium of claim 15, wherein the second seating object is selected to balance a distribution of seatings among a plurality of servers wherein a portion of the plurality of seating objects is associated with each of the servers.

18. The computer readable medium of claim 1, further comprising computer code for receiving inputs, including a party size and/or one or more seating preference parameters, associated with a second party which has arrived at the establishment without any reservation and based upon the party size and one or more seating preference parameters, computer code for selecting two or more second seating objects for the second party in accordance with the received party size and/or the received one or more seating preference parameters, computer code for indicating and temporarily holding the two or more second seating objects, computer code for receiving a selection of one of the two or more second seating objects at which the second party is seated and computer code releasing the temporary holds on any seating objects at which the second party is not seated.

19. The computer readable medium of claim 1, further comprising computer code for determining an input indicating an arrival of the party at the restaurant has not been received and computer code for generating an alert associated with the reservation.

20. The computer readable medium of claim 1, further comprising computer code for indicating the first seating object associated with the reservation, computer code for receiving a second seating object at which the party is to be seated and computer code for releasing the first seating object such that the first seating object is available for seating other parties.

21. The computer readable medium of claim 1, further comprising computer code for receiving an indication the party seated at the first seating object has left.

22. The computer readable medium of claim 21, further comprising computer code for determining, based upon when the indication the party has left, an amount of time the party used the first seating object and computer code for determining whether the amount of time is to be added to a historical database which includes seating times associated with the first seating object used to predict how long seatings will last at the first seating object.

23. The computer readable medium of claim 1, wherein the second amount of time is predicted based upon how long a plurality of past seatings associated with the first seating object have lasted.

24. The computer readable medium of claim 1, further comprising computer code for associating the first seating object with a particular server.
